(19) United States
(12) Patent Application Publication
(10) Pub. No.: US 2024/0171732 A1
(43) Pub. Date: May 23, 2024

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Yang WANG, Beijing (CN); Li ZHANG, Los Angeles, CA (US); Kai ZHANG, Los Angeles, CA (US)

(21) Appl. No.: 18/412,193

(22) Filed: Jan. 12, 2024

Related U.S. Application Data
(63) Continuation of application No. PCT/CN2022/105009, filed on Jul. 11, 2022.

(30) Foreign Application Priority Data
Jul. 14, 2021 (WO) PCT/CN2021/106291

(51) Int. Cl. H04N 19/105; H04N 19/147; H04N 19/159; H04N 19/176; H04N 19/513

(52) U.S. Cl. CPC H04N 19/105; H04N 19/147; H04N 19/159; H04N 19/176; H04N 19/521

(57) ABSTRACT

Embodiments of the present disclosure provide a solution for video processing. A method for video processing is proposed. The method comprises: determining, during a conversion between a video unit of a video and a bitstream of the video unit, a plurality of predicted signals based on coding information of the video unit, the video unit being coded with a non-intra coding mode, and the plurality predicted signals comprising at least one of: a basic predicted signal or an additional predicted signal; determining a final predicted signal for the video unit based on the plurality of predicted signals; and performing the conversion based on the final predicted signal for the video unit.

### CROSS-REFERENCE TO RELATED APPLICATIONS

This application is a continuation of International Application No. PCT/CN2022/105009, filed on Jul. 11, 2022, which claims the benefit of International Application No. PCT/CN2021/106291 filed on Jul. 14, 2021. The entire contents of these applications are hereby incorporated by reference in their entireties.

### FIELD

Embodiments of the present disclosure relates generally to video coding techniques, and more particularly, to fusion for inter coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, during a conversion between a video unit of a video and a bitstream of the video unit, a plurality of predicted signals based on coding information of the video unit, the video unit being coded with a non-intra coding mode, and the plurality predicted signals comprising at least one of: a basic predicted signal or an additional predicted signal; determining a final predicted signal for the video unit based on the plurality of predicted signals; and performing the conversion based on the final predicted signal for the video unit. Compared with conventional technologies, multiple predicted signals are used for determining the final predicted signal, which improves coding performance. Furthermore, coding efficiency can be improved.

In a second aspect, an apparatus for processing video data is proposed. The apparatus for processing video data comprising a processor and a non-transitory memory with instructions thereon, wherein the instructions upon execution by the processor, cause the processor to determine, during a conversion between a video unit of a video and a bitstream of the video unit, a plurality of predicted signals based on coding information of the video unit, the video unit being coded with a non-intra coding mode, and the plurality predicted signals comprising at least one of: a basic predicted signal or an additional predicted signal; determine a final predicted signal for the video unit based on the plurality of predicted signals; and perform the conversion based on the final predicted signal for the video unit. Compared with conventional technologies, multiple predicted signals are used, which improves coding performance. Furthermore, coding efficiency can be improved.

In a third aspect, an apparatus for processing video data is proposed. The non-transitory computer-readable storage medium storing instructions that cause a processor to perform a method. The method comprises: determining, during a conversion between a video unit of a video and a bitstream of the video unit, a plurality of predicted signals based on coding information of the video unit, the video unit being coded with a non-intra coding mode, and the plurality predicted signals comprising at least one of: a basic predicted signal or an additional predicted signal; determining a final predicted signal for the video unit based on the plurality of predicted signals; and performing the conversion based on the final predicted signal for the video unit. Compared with conventional technologies, multiple predicted signals are used, which improves coding performance. Furthermore, coding efficiency can be improved.

In a fourth aspect, a non-transitory computer-readable recording medium is proposed. The non-transitory computer-readable recording medium storing a bitstream of a video which is generated by a method performed by a video processing apparatus, wherein the method comprises: determining a plurality of predicted signals based on coding information of a video unit, the video unit being coded with a non-intra coding mode, and the plurality predicted signals comprising at least one of: a basic predicted signal or an additional predicted signal; determining a final predicted signal for the video unit based on the plurality of predicted signals; and generating a bitstream of the video unit based on the final predicted signal for the video unit. Compared with conventional technologies, multiple predicted signals are used, which improves coding performance. Furthermore, coding efficiency can be improved.

In a fifth aspect, a method for video processing is proposed. The method comprises determining a plurality of predicted signals based on coding information of a video unit, the video unit being coded with a non-intra coding mode, and the plurality predicted signals comprising at least one of: a basic predicted signal or an additional predicted signal; determining a final predicted signal for the video unit based on the plurality of predicted signals; generating a bitstream of the video unit the final predicted signal for the video unit; and storing the bitstream in a non-transitory computer-readable recording medium. Compared with conventional technologies, multiple predicted signals are used, which improves coding performance. Furthermore, coding efficiency can be improved.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4. illustrates an example of encoder block diagram;

FIG. 5 illustrates 67 intra prediction modes;

FIG. 6 illustrates reference samples for wide-angular intra prediction;

FIG. 7 illustrates problem of discontinuity in case of directions beyond 45°;

FIG. 8 illustrates MMVD Search Point;

FIG. 9 illustrates illustration for symmetrical MVD mode;

FIG. 10 illustrates extended CU region used in BDOF;

FIG. 11 illustrates control point based affine motion model;

FIG. 12 illustrates affine MVF per subblock;

FIG. 13 illustrates locations of inherited affine motion predictors;

FIG. 14 illustrates control point motion vector inherirtance;

FIG. 15 illustrates locations of Candidates position for constructed affine merge mode;

FIG. 16 illustrates illustration of motion vector usage for proposed combined method;

FIG. 17 illustrates subblock MV VSB and pixel Δv(i,j);

FIG. 18A illustrates a schematic diagram of spatial neighboring blocks used by SbTMVP and FIG. 18B illustrates a schematic diagram of driving sub-CU motion field by applying a motion shift from spatial neighbor and scaling the motion information from the corresponding collocated sub-CUs;

FIG. 19 illustrates local illumination compensation;

FIG. 20 illustrates no subsampling for the short side;

FIG. 21 illustrates decoding side motion vector refinement;

FIG. 22 illustrates diamond regions in the search area;

FIG. 23 illustrates positions of spatial merge candidate;

FIG. 24 illustrates candidate pairs considered for redundancy check of spatial merge candidates;

FIG. 25 illustrates illustration of motion vector scaling for temporal merge candidate;

FIG. 26 illustrates candidate positions for temporal merge candidate, C0 and C1;

FIG. 27 illustrates a block diagram illustrating an example of video encoder;

FIG. 28 illustrates the relationship between the virtual block (i.e., Aᵢ, Bᵢ, Cᵢ, Dᵢ and Eᵢ) and the current block (illustration of virtual block in the i-th search round);

FIG. 29 illustrates examples of the GPM splits grouped by identical angles;

FIG. 30 illustrates uni-prediction MV selection for geometric partitioning mode;

FIG. 31 illustrates exemplified generation of a bending weight w_0 using geometric partitioning mode;

FIG. 32 illustrates spatial neighboring blocks used to derive the spatial merge candidates;

FIG. 33 illustrates template matching performs on a search area around initial MV;

FIG. 34 illustrates illustration of sub-blocks where OBMC applies;

FIG. 35 illustrates SBT position, type and transform type;

FIG. 36 illustrates a flow chart of a method according to embodiments of the present disclosure; and

FIG. 37 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

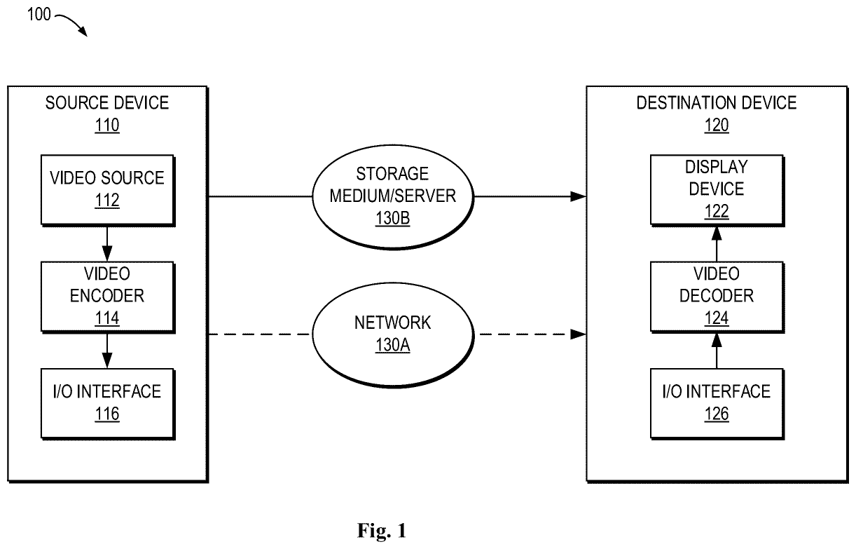

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

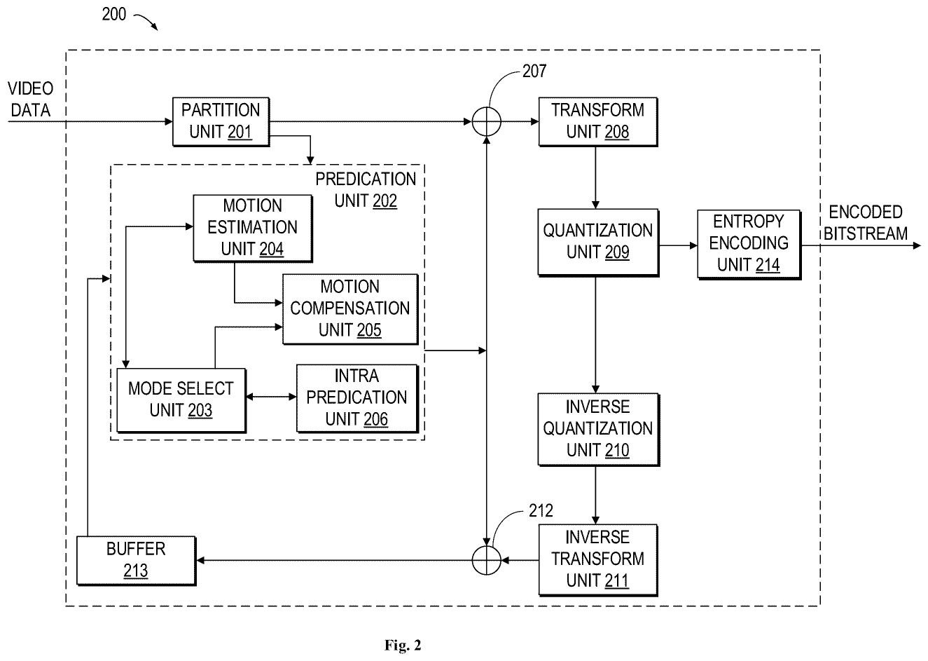

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

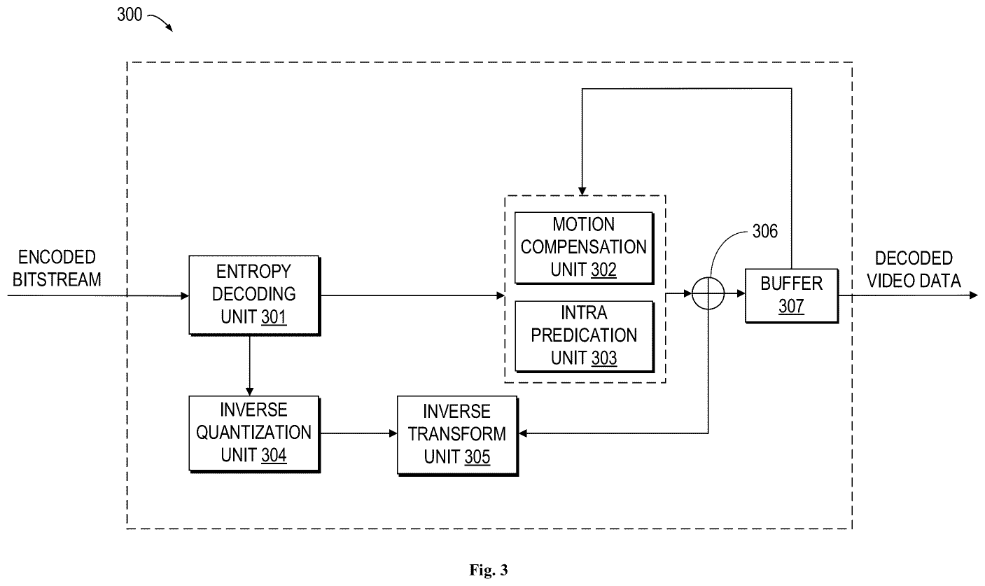

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Summary

Embodiments of the present disclosure are related to video coding technologies. Specifically, it is related fusion for inter coding which uses multiple predicted signals to obtain the final predicted signal for a video unit, how to and/or whether to apply the fusion method, and other coding tools in image/video coding. It may be applied to the conventional video coding standard like HEVC, or Versatile Video Coding (VVC). It may be also applicable to future video coding standards or video codec.

### 2. Background

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC.

The latest version of VVC draft, i.e., Versatile Video Coding (Draft 10) could be found at: http://phenix.it-sudparis.eu/jvet/doc_end_user/documents/20_Teleconference/wg11/JVET-T2001-v1.zip

The latest reference software of VVC, named VTM, could be found at: https://vcgit.hhi.fraunhofer.de/jvet/VVCSoftware_VTM/-/tags/VTM-11.0

2.1. Coding Flow of a Typical Video Codec

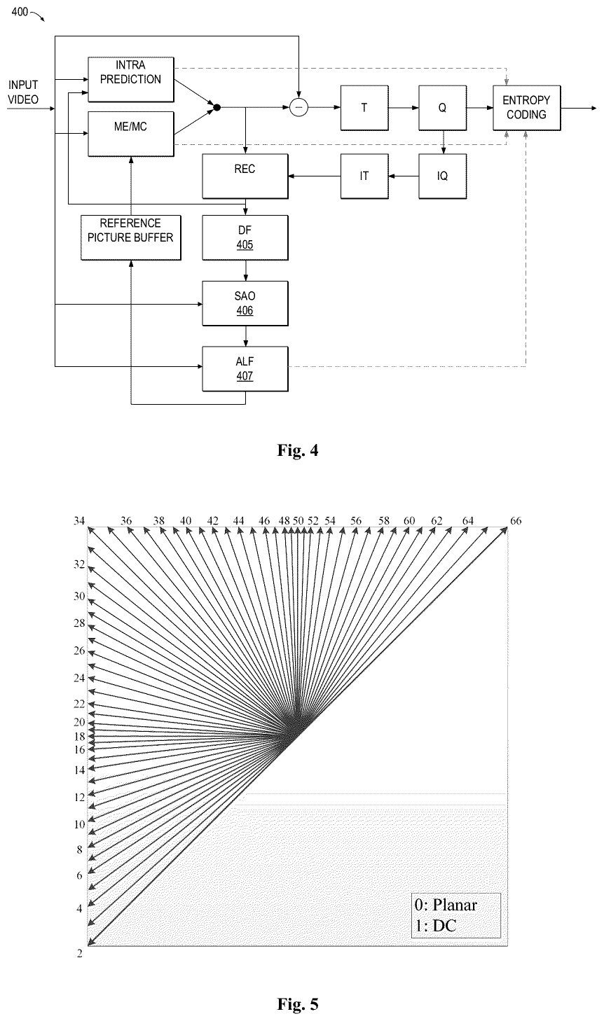

FIG. 4 shows an example of encoder block diagram 400 of VVC, which contains three in-loop filtering blocks: deblocking filter (DF) 405, sample adaptive offset (SAO) 406 and ALF 407. Unlike DF 405, which uses predefined filters, SAO 406 and ALF 407 utilize the original samples of the current picture to reduce the mean square errors between the original samples and the reconstructed samples by adding an offset and by applying a finite impulse response (FIR) filter, respectively, with coded side information signalling the offsets and filter coefficients. ALF is located at the last processing stage of each picture and can be regarded as a tool trying to catch and fix artifacts created by the previous stages.

2.2. Intra Mode Coding with 67 Intra Prediction Modes

To capture the arbitrary edge directions presented in natural video, the number of directional intra modes is extended from 33, as used in HEVC, to 65, as shown in FIG. 5, and the planar and DC modes remain the same. These denser directional intra prediction modes apply for all block sizes and for both luma and chroma intra predictions.

In the HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

2.2.1. Wide Angle Intra Prediction

Although 67 modes are defined in the VVC, the exact prediction direction for a given intra prediction mode index is further dependent on the block shape. Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

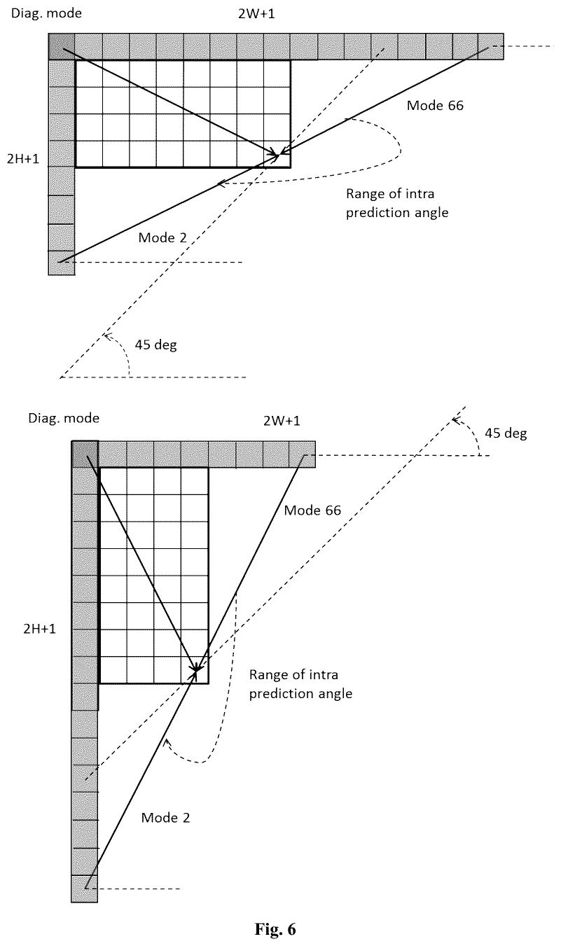

To support these prediction directions, the top reference with length 2W+1, and the left reference with length 2H+1, are defined as shown in FIG. 6.

The number of replaced modes in wide-angular direction mode depends on the aspect ratio of a block. The replaced intra prediction modes are illustrated in Table 2-1

TABLE 2-1
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, 65, 66 |

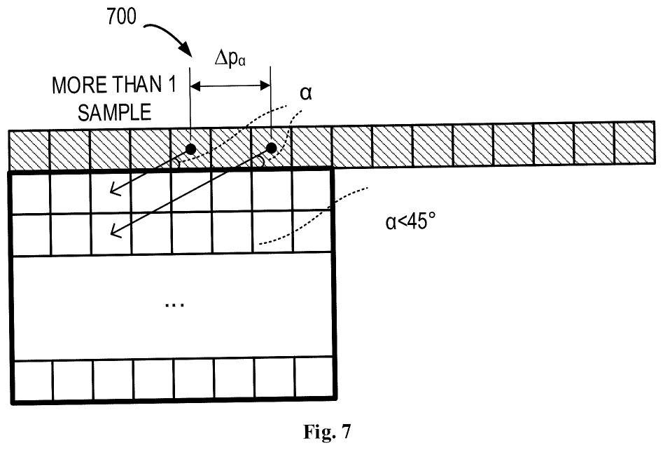

FIG. 7 illustrates a block diagram of discontinuity in case of directions beyond 45 degree. As shown in FIG. 7, two vertically adjacent predicted samples may use two non-adjacent reference samples in the case of wide-angle intra prediction. Hence, low-pass reference samples filter and side smoothing are applied to the wide-angle prediction to reduce the negative effect of the increased gap Δp_{α}. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes.

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

2.3. Inter Prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

2.4. Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 sub-blocks. For the current block of a larger size, a hash key is determined to match that of the reference block when all the hash keys of all 4×4 sub-blocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signalled as IBC AMVP mode or IBC skip/merge mode as follows:
IBC skip/merge mode: a merge candidate index is used to indicate which of the block vectors in the list from neighbouring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbour and one from above neighbour (if IBC coded). When either neighbour is not available, a default block vector will be used as a predictor. A flag is signalled to indicate the block vector predictor index.

2.5. Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a skip flag and merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The merge candidate flag is signalled to specify which one is used.

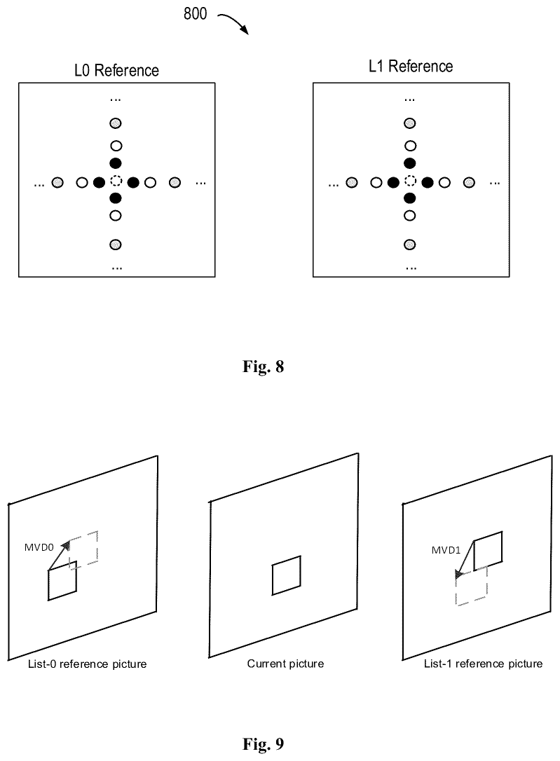

Distance index specifies motion magnitude information and indicate the pre-defined offset from the starting point. FIG. 8 is a schematic diagram 800 illustrating a merge mode with motion vector differences (MMVD) search point. As shown in FIG. 8, an offset is added to either horizontal component or vertical component of starting MV. The relation of distance index and pre-defined offset is specified in Table 2-2.

TABLE 2-2
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 2-3. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 2-3 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), and the difference of POC in list 0 is greater than the one in list 1, the sign in Table 2-3 specifies the sign of MV offset added to the list0 MV component of starting MV and the sign for the list1 MV has opposite value. Otherwise, if the difference of POC in list 1 is greater than list 0, the sign in Table 2-3 specifies the sign of MV offset added to the list1 MV component of starting MV and the sign for the list0 MV has opposite value.

The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb, described in FIG. 9. If the POC difference of L1 is greater than L0, the MVD for list 0 is scaled in the same way. If the starting MV is uni-predicted, the MVD is added to the available MV.

TABLE 2-3
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

2.6. Symmetric MVD Coding

In VVC, besides the normal unidirectional prediction and bi-directional prediction mode MVD signalling, symmetric MVD mode for bi-predictional MVD signalling is applied. In the symmetric MVD mode, motion information including reference picture indices of both list-0 and list-1 and MVD of list-1 are not signaled but derived.

The decoding process of the symmetric MVD mode is as follows:
1. At slice level, variables BiDirPredFlag, RefIdxSymL0 and RefIdxSymL1 are derived as follows:
   If mvd_l1_zero_flag is 1, BiDirPredFlag is set equal to 0.
   Otherwise, if the nearest reference picture in list-0 and the nearest reference picture in list-1 form a forward and backward pair of reference pictures or a backward and forward pair of reference pictures, BiDirPredFlag is set to 1, and both list-0 and list-1 reference pictures are short-term reference pictures. Otherwise BiDirPredFlag is set to 0.
2. At CU level, a symmetrical mode flag indicating whether symmetrical mode is used or not is explicitly signaled if the CU is bi-prediction coded and BiDirPredFlag is equal to 1.

When the symmetrical mode flag is true, only mvp_l0_flag, mvp_l1_flag and MVD0 are explicitly signaled. The reference indices for list-0 and list-1 are set equal to the pair of reference pictures, respectively. MVD1 is set equal to (−MVD0). The final motion vectors are shown in below formula.

$$\{ \begin{matrix}( mv {x}_{0} , mv {y}_{0} ) = ( m v p {x}_{0} + m v d {x}_{0} , mvp {y}_{0} + m v d {y}_{0} ) \\ ( mv {x}_{1} , mv {y}_{1} ) = ( m v p {x}_{1} - m v d {x}_{0} , mvp {y}_{1} - m v d {y}_{0} )\end{matrix} \qquad ( 2 - 1 )$$

In the encoder, symmetric MVD motion estimation starts with initial MV evaluation. A set of initial MV candidates comprising of the MV obtained from uni-prediction search, the MV obtained from bi-prediction search and the MVs from the AMVP list. The one with the lowest rate-distortion cost is chosen to be the initial MV for the symmetric MVD motion search.

2.7. Bi-Directional Optical Flow (BDOF)

The bi-directional optical flow (BDOF) tool is included in VVC. BDOF, previously referred to as BIO, was included in the JEM. Compared to the JEM version, the BDOF in VVC is a simpler version that requires much less computation, especially in terms of number of multiplications and the size of the multiplier.

BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order
The distances (i.e. POC difference) from two reference pictures to the current picture are same
Both reference pictures are short-term reference pictures.
The CU is not coded using affine mode or the SbTMVP merge mode
CU has more than 64 luma samples
Both CU height and CU width are larger than or equal to 8 luma samples
BCW weight index indicates equal weight
WP is not enabled for the current CU
CIIP mode is not used for the current CU

BDOF is only applied to the luma component. As its name indicates, the BDOF mode is based on the optical flow concept, which assumes that the motion of an object is smooth. For each 4×4 subblock, a motion refinement (vₓ, v_{y}) is calculated by minimizing the difference between the L0 and L1 prediction samples. The motion refinement is then used to adjust the bi-predicted sample values in the 4×4 subblock. The following steps are applied in the BDOF process.

First, the horizontal and vertical gradients,

$$\frac{\partial {I}^{( k )}}{\partial x} ( i , j ) and \frac{\partial {I}^{( k )}}{\partial y} ( i , j ) ,$$

k=0, 1, of the two prediction signals are computed by directly calculating the difference between two neighboring samples, i.e.,

$$\frac{\partial {I}^{( k )}}{\partial x} ( i , j ) = ( ( {I}^{( k )} ( i + 1 , j ) ≫ shift 1 ) - ( {I}^{( k )} ( i - 1 , j ) ≫ shift 1 ) ) \qquad ( 2 - 2 )$$

$$\frac{\partial {I}^{( k )}}{\partial y} ( i , j ) = ( ( {I}^{( k )} ( i , j + 1 ) ≫ shift 1 ) - ( {I}^{( k )} ( i , j - 1 ) ≫ shift 1 ) )$$

where I^{(k)} (i,j) are the sample value at coordinate (i,j) of the prediction signal in list k, k=0, 1, and shift1 is calculated based on the luma bit depth, bitDepth, as shift1=max(6, bitDepth−6). Then, the auto- and cross-correlation of the gradients, S₁, S₂, S₃, S₅ and S₆, are calculated as

$${S}_{1} = {\sum }_{( i , j ) ∈ Ω} Abs ( {ψ}_{x} ( i , j ) ) , {S}_{3} = {\sum }_{( i , j ) ∈ Ω} θ ( i , j ) \cdot Sign ( {ψ}_{x} ( i , j ) ) \qquad ( 2 - 3 )$$

$${S}_{2} = {\sum }_{( i , j ) ∈ Ω} {ψ}_{x} ( i , j ) \cdot Sign ( {ψ}_{y} ( i , j ) )$$

$${S}_{5} = {\sum }_{( i , j ) ∈ Ω} Abs ( {ψ}_{y} ( i , j ) ) , {S}_{6} = {\sum }_{( i , j ) ∈ Ω} θ ( i , j ) \cdot Sign ( {ψ}_{y} ( i , j ) )$$

$$where {ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a} \qquad ( 2 - 4 )$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a}$$

$$θ ( i , j ) = ( {I}^{( 1 )} ( i , j ) ≫ {n}_{b} ) - ( {I}^{( 0 )} ( i , j ) ≫ {n}_{b} )$$

where Ω is a 6×6 window around the 4×4 subblock, and the values of nₐ and n_{b} are set equal to min(1, bitDepth−11) and min(4, bitDepth−8), respectively.

The motion refinement (vₓ, v_{y}) is then derived using the cross- and auto-correlation terms using the following:

vₓ=S₁>0?clip3(−th′_{BIO},th′_{BIO},−((S₃·2ⁿ^{_{b}}⁻ⁿ^{ₐ})>>└log₂ S₁┘)):0

v_{y}=S₅>0?clip3(−th′_{BIO},th′_{BIO},−((S₆·2ⁿ^{_{b}}⁻ⁿ^{ₐ}−((vₓS_{2,m})<<n_{S}_{₂}+vₓS_{2,s})/2)>>└log₂ S₅┘)):0 (2-5)

where S_{2,m}=S₂>>n_{S}_{₂}, S_{2,s}=S₂&(2ⁿ^{_{S2}}−1), th′_{BIO}=2^{max(5,BD-7)}. └·┘ is the floor function, and n_{S}_{₂}=12.

Based on the motion refinement and the gradients, the following adjustment is calculated for each sample in the 4×4 subblock:

$$b ( x , y ) = rnd ( ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) / 2 ) \qquad ( 2 - 6 )$$

Finally, the BDOF samples of the CU are calculated by adjusting the bi-prediction samples as follows:

pred_{BDOF}(x,y)=I⁽⁰⁾+I⁽¹⁾+b(x,y)+o_{offset})>>shift (27)

These values are selected such that the multipliers in the BDOF process do not exceed 15-bit, and the maximum bit-width of the intermediate parameters in the BDOF process is kept within 32-bit.

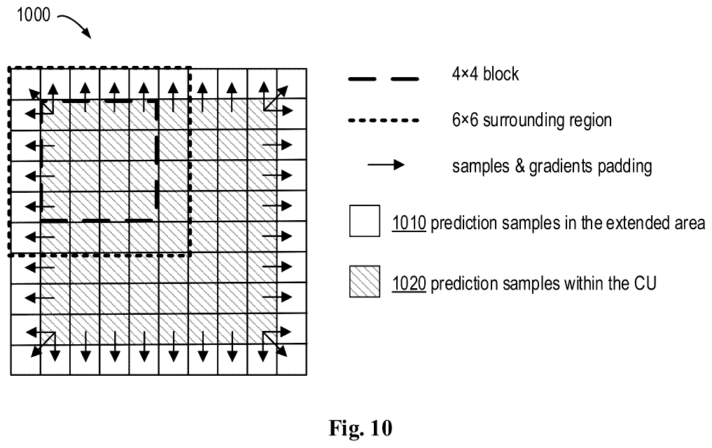

In order to derive the gradient values, some prediction samples I\hat{ }((k)) (i,j) in list k (k=0, 1) outside of the current CU boundaries need to be generated. FIG. 10 illustrates a schematic diagram of extended CU region used in BDOF. As depicted in the diagram 1000 of FIG. 10, the BDOF in VVC uses one extended row/column around the CU's boundaries. In order to control the computational complexity of generating the out-of-boundary prediction samples, prediction samples in the extended area (denoted as 1010 in FIG. 10) are generated by taking the reference samples at the nearby integer positions (using floor ( ) operation on the coordinates) directly without interpolation, and the normal 8-tap motion compensation interpolation filter is used to generate prediction samples within the CU (denoted as 1020 in FIG. 10). These extended sample values are used in gradient calculation only. For the remaining steps in the BDOF process, if any sample and gradient values outside of the CU boundaries are needed, they are padded (i.e. repeated) from their nearest neighbors.

When the width and/or height of a CU are larger than 16 luma samples, it will be split into subblocks with width and/or height equal to 16 luma samples, and the subblock boundaries are treated as the CU boundaries in the BDOF process. The maximum unit size for BDOF process is limited to 16×16. For each subblock, the BDOF process could skipped. When the SAD of between the initial L0 and L1 prediction samples is smaller than a threshold, the BDOF process is not applied to the subblock. The threshold is set equal to (8*W*(H>>1), where W indicates the subblock width, and H indicates subblock height. To avoid the additional complexity of SAD calculation, the SAD between the initial L0 and L1 prediction samples calculated in DVMR process is re-used here.

If BCW is enabled for the current block, i.e., the BCW weight index indicates unequal weight, then bi-directional optical flow is disabled. Similarly, if WP is enabled for the current block, i.e., the luma_weight_lx_flag is 1 for either of the two reference pictures, then BDOF is also disabled. When a CU is coded with symmetric MVD mode or CIIP mode, BDOF is also disabled.

2.8. Combined Inter and Intra Prediction (CIIP)

2.9. Affine Motion Compensated Prediction

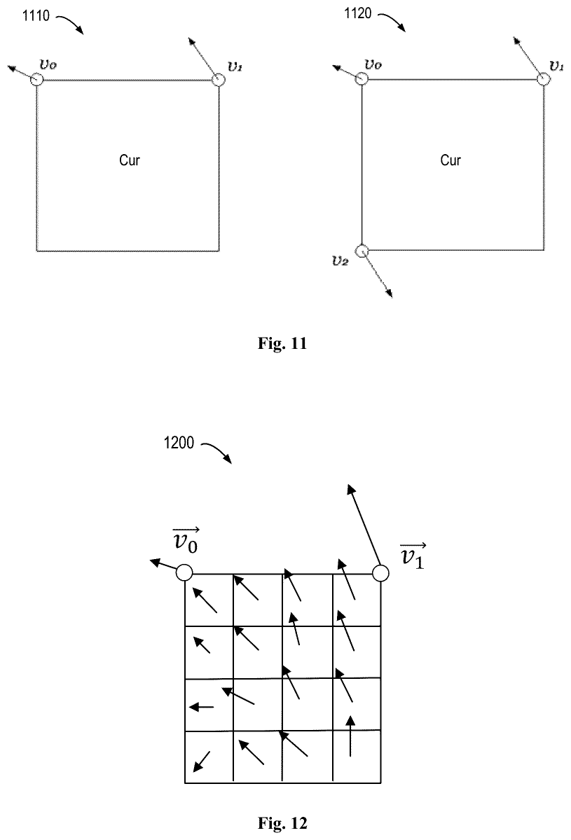

In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction is applied. FIG. 11 illustrates a schematic diagram of control point based affine motion model. As shown FIG. 11, the affine motion field of the block is described by motion information of two control point (4-parameter) or three control point motion vectors (6-parameter).

For the 4-parameter affine motion model 1110 in FIG. 11, motion vector at sample location (x, y) in a block is derived as:

$$\{ \begin{matrix}m {v}_{x} = \frac{m {v}_{1 x} - m {v}_{0 x}}{W} x + \frac{m {v}_{0 y} - m {v}_{1 y}}{W} y + m {v}_{0 x} \\ m {v}_{y} = \frac{m {v}_{1 y} - m {v}_{0 y}}{W} x + \frac{m {v}_{1 x} - m {v}_{0 x}}{W} y + m {v}_{0 y}\end{matrix}$$

For the 6-parameter affine motion model 1120 in FIG. 11, motion vector at sample location (x, y) in a block is derived as:

$$\{ \begin{matrix}m {v}_{x} = \frac{m {v}_{1 x} - m {v}_{0 x}}{W} x + \frac{m {v}_{2 x} - m {v}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix}$$

Where (mv₀ₓ, mv_{0y}) is motion vector of the top-left corner control point, (mv₁ₓ, mv_{1y}) is motion vector of the top-right corner control point, and (mv₂ₓ, mv_{2y}) is motion vector of the bottom-left corner control point.

In order to simplify the motion compensation prediction, block based affine transform prediction is applied. FIG. 12 illustrates a schematic diagram 1200 of affine MVF per subblock. To derive motion vector of each 4×4 luma subblock, the motion vector of the center sample of each subblock, as shown in FIG. 12, is calculated according to above equations, and rounded to 1/16 fraction accuracy. Then the motion compensation interpolation filters are applied to generate the prediction of each subblock with derived motion vector. The subblock size of chroma-components is also set to be 4×4. The MV of a 4×4 chroma subblock is calculated as the average of the MVs of the top-left and bottom-right luma subblocks in the collocated 8×8 luma region.

As done for translational motion inter prediction, there are also two affine motion inter prediction modes: affine merge mode and affine AMVP mode.

2.9.1. Affine Merge Prediction

AF_MERGE mode can be applied for CUs with both width and height larger than or equal to 8. In this mode the CPMVs of the current CU is generated based on the motion information of the spatial neighboring CUs. There can be up to five CPMVP candidates and an index is signalled to indicate the one to be used for the current CU. The following three types of CPVM candidate are used to form the affine merge candidate list:
Inherited affine merge candidates that extrapolated from the CPMVs of the neighbour CUs
Constructed affine merge candidates CPMVPs that are derived using the translational MVs of the neighbour CUs
Zero MVs

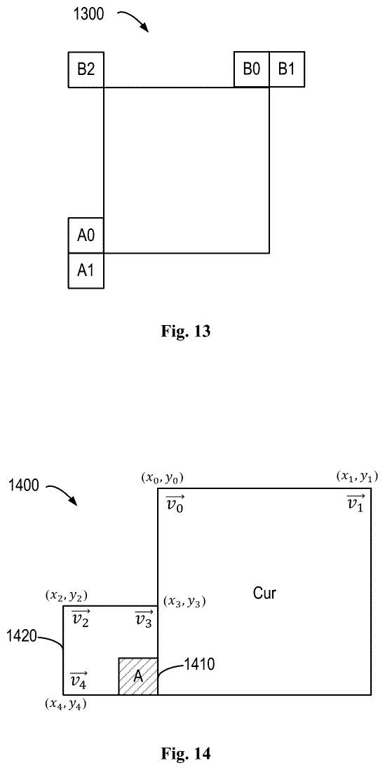

In VVC, there are maximum two inherited affine candidates, which are derived from affine motion model of the neighboring blocks, one from left neighboring CUs and one from above neighboring CUs. FIG. 13 illustrates a schematic diagram 1300 of locations of inherited affine motion predictors. The candidate blocks are shown in FIG. 13. For the left predictor, the scan order is A0->A1, and for the above predictor, the scan order is B0->B1->B2. Only the first inherited candidate from each side is selected. No pruning check is performed between two inherited candidates. When a neighboring affine CU is identified, its control point motion vectors are used to derive the CPMVP candidate in the affine merge list of the current CU. FIG. 14 illustrates a schematic diagram of control point motion vector inheritance. As shown in FIG. 14, if the neighbour left bottom block A 1410 is coded in affine mode, the motion vectors v₂, v₃ and v₄ of the top left corner, above right corner and left bottom corner of the CU 1420 which contains the block A 1410 are attained. When block A 1410 is coded with 4-parameter affine model, the two CPMVs of the current CU are calculated according to v₂, and v₃. In case that block A is coded with 6-parameter affine model, the three CPMVs of the current CU are calculated according to v₂, v₃ and v₄.

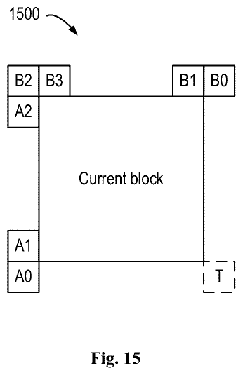

Constructed affine candidate means the candidate is constructed by combining the neighbor translational motion information of each control point. The motion information for the control points is derived from the specified spatial neighbors and temporal neighbor shown in FIG. 15 which illustrates a schematic diagram 1500 of locations of candidates position for constructed affine merge mode. CPMVₖ (k=1, 2, 3, 4) represents the k-th control point. For CPMV₁, the B2->B3->A2 blocks are checked and the MV of the first available block is used. For CPMV₂, the B1->B0 blocks are checked and for CPMV₃, the A1->A0 blocks are checked. TMVP is used as CPMV₄ if it's available.

After MVs of four control points are attained, affine merge candidates are constructed based on those motion information. The following combinations of control point MVs are used to construct in order: {CPMV₁, CPMV₂, CPMV₃}, {CPMV₁, CPMV₂, CPMV₄}, {CPMV₁, CPMV₃, CPMV₄}, {CPMV₂, CPMV₃, CPMV₄}, {CPMV₁, CPMV₂}, {CPMV₁, CPMV₃}

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

After inherited affine merge candidates and constructed affine merge candidate are checked, if the list is still not full, zero MVs are inserted to the end of the list.

2.9.2. Affine AMVP Prediction

Affine AMVP mode can be applied for CUs with both width and height larger than or equal to 16. An affine flag in CU level is signalled in the bitstream to indicate whether affine AMVP mode is used and then another flag is signalled to indicate whether 4-parameter affine or 6-parameter affine. In this mode, the difference of the CPMVs of current CU and their predictors CPMVPs is signalled in the bitstream. The affine AVMP candidate list size is 2 and it is generated by using the following four types of CPVM candidate in order:
Inherited affine AMVP candidates that extrapolated from the CPMVs of the neighbour CUs
Constructed affine AMVP candidates CPMVPs that are derived using the translational MVs of the neighbour CUs
Translational MVs from neighbouring CUs
Zero MVs

The checking order of inherited affine AMVP candidates is same to the checking order of inherited affine merge candidates. The only difference is that, for AVMP candidate, only the affine CU that has the same reference picture as in current block is considered. No pruning process is applied when inserting an inherited affine motion predictor into the candidate list.

Constructed AMVP candidate is derived from the specified spatial neighbours shown in FIG. 15. The same checking order is used as done in affine merge candidate construction. In addition, reference picture index of the neighbouring block is also checked. The first block in the checking order that is inter coded and has the same reference picture as in current CUs is used. There is only one When the current CU is coded with 4-parameter affine mode, and mv₀ and mv₁ are both available, they are added as one candidate in the affine AMVP list. When the current CU is coded with 6-parameter affine mode, and all three CPMVs are available, they are added as one candidate in the affine AMVP list. Otherwise, constructed AMVP candidate is set as unavailable.

If affine AMVP list candidates is still less than 2 after inherited affine AMVP candidates and Constructed AMVP candidate are checked, mv₀, mv₁, and mv₂ will be added, in order, as the translational MVs to predict all control point MVs of the current CU, when available. Finally, zero MVs are used to fill the affine AMVP list if it is still not full.

2.9.3. Affine Motion Information Storage

In VVC, the CPMVs of affine CUs are stored in a separate buffer. The stored CPMVs are only used to generate the inherited CPMVPs in affine merge mode and affine AMVP mode for the lately coded CUs. The subblock MVs derived from CPMVs are used for motion compensation, MV derivation of merge/AMVP list of translational MVs and de-blocking.

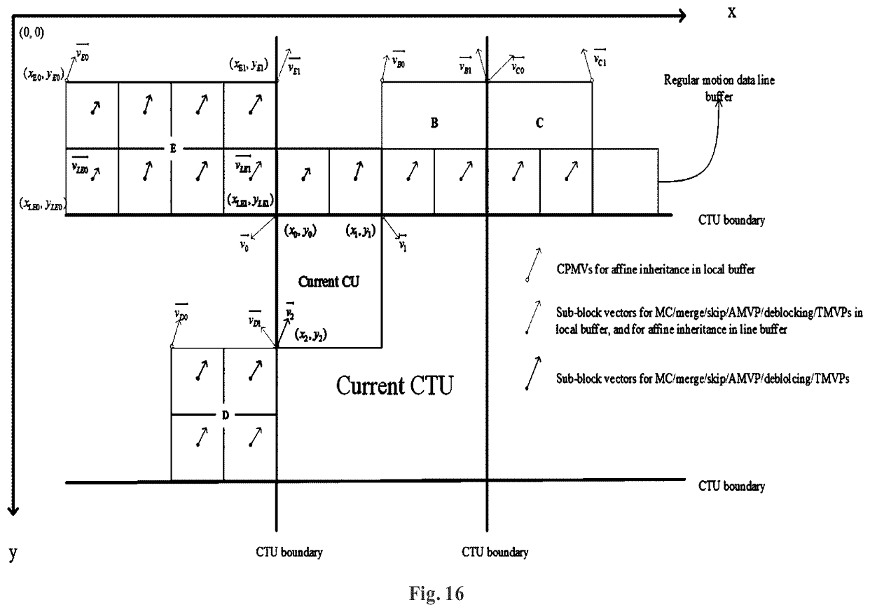

To avoid the picture line buffer for the additional CPMVs, affine motion data inheritance from the CUs from above CTU is treated differently to the inheritance from the normal neighbouring CUs. If the candidate CU for affine motion data inheritance is in the above CTU line, the bottom-left and bottom-right subblock MVs in the line buffer instead of the CPMVs are used for the affine MVP derivation. In this way, the CPMVs are only stored in local buffer. If the candidate CU is 6-parameter affine coded, the affine model is degraded to 4-parameter model. As shown in FIG. 16, along the top CTU boundary, the bottom-left and bottom right subblock motion vectors of a CU are used for affine inheritance of the CUs in bottom CTUs.

2.9.4. Prediction Refinement with Optical Flow for Affine Mode

Subblock based affine motion compensation can save memory access bandwidth and reduce computation complexity compared to pixel-based motion compensation, at the cost of prediction accuracy penalty. To achieve a finer granularity of motion compensation, prediction refinement with optical flow (PROF) is used to refine the subblock based affine motion compensated prediction without increasing the memory access bandwidth for motion compensation. In VVC, after the subblock based affine motion compensation is performed, luma prediction sample is refined by adding a difference derived by the optical flow equation. The PROF is described as following four steps: Step 1) The subblock-based affine motion compensation is performed to generate subblock prediction I(i,j).

Step 2) The spatial gradients gₓ(i,j) and g_{y}(i,j) of the subblock prediction are calculated at each sample location using a 3-tap filter [−1, 0, 1]. The gradient calculation is exactly the same as gradient calculation in BDOF.

gₓ(i,j)=(I(i+1,j)>>shift1)−(I(i−1,j)>>shift1) (2-10)

g_{y}(i,j)=(I(i,j+1)>>shift1)−(I(i,j−1)>>shift1) (2-11)

shift1 is used to control the gradient's precision. The subblock (i.e. 4×4) prediction is extended by one sample on each side for the gradient calculation. To avoid additional memory bandwidth and additional interpolation computation, those extended samples on the extended borders are copied from the nearest integer pixel position in the reference picture.

Step 3) The luma prediction refinement is calculated by the following optical flow equation.

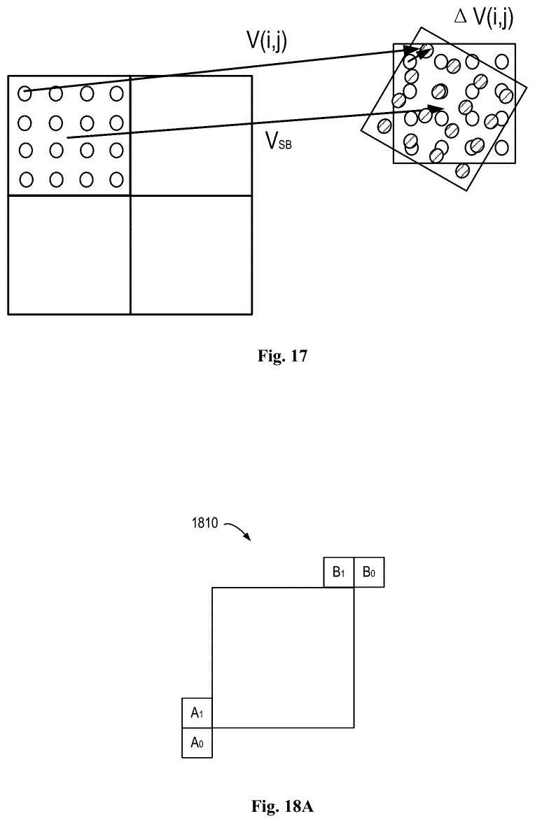

ΔI(i,j)=gₓ(i,j)*Δvₓ(i,j)+g_{y}(i,j)*Δv_{y}(i,j) (2-12)

where the Δv(i,j) is the difference between sample MV computed for sample location (i,j), denoted by v(i,j), and the subblock MV of the subblock to which sample (i,j) belongs, as shown in FIG. 17. The Δv(i,j) is quantized in the unit of 1/32 luam sample precision.

Since the affine model parameters and the sample location relative to the subblock center are not changed from subblock to subblock, Δv(i,j) can be calculated for the first subblock, and reused for other subblocks in the same CU. Let dx(i,j) and dy(i,j) be the horizontal and vertical offset from the sample location (i,j) to the center of the subblock (x_{SB}, y_{SB}), Δv(x, y) can be derived by the following equation,

$$\{ \begin{matrix}d x ( i , j ) = i - {x}_{S B} \\ d y ( i , j ) = j - {y}_{S B}\end{matrix} \qquad ( 2 - 13 )$$

$$\{ \begin{matrix}Δ {v}_{x} ( i , j ) = C * d x ( i , j ) + D * d y ( i , j ) \\ Δ {v}_{y} ( i , j ) = E * d x ( i , j ) + F * d y ( i , j )\end{matrix} \qquad ( 2 - 14 )$$

In order to keep accuracy, the enter of the subblock (x_{SB}, y_{SB}) is calculated as ((W_{SB}−1)/2, (H_{SB}−1)/2), where W_{SB} and H_{SB} are the subblock width and height, respectively.

For 4-parameter affine model,

$$\{ \begin{matrix}C = F = \frac{{v}_{1 x} - {v}_{0 x}}{w} \\ E = - D = \frac{{v}_{1 y} - {v}_{0 y}}{w}\end{matrix} \qquad ( 2 - 15 )$$

For 6-parameter affine model,

$$\{ \begin{matrix}C = \frac{{v}_{1 x} - {v}_{0 x}}{w} \\ D = \frac{{v}_{2 x} - {v}_{0 x}}{h} \\ E = \frac{{v}_{1 y} - {v}_{0 y}}{w} \\ F = \frac{{v}_{2 y} - {v}_{0 y}}{h}\end{matrix} \qquad ( 2 - 16 )$$

where (v₀ₓ, v_{0y}), (v₁ₓ, v_{1y}), (v₂ₓ, v_{2y}) are the top-left, top-right and bottom-left control point motion vectors, w and h are the width and height of the CU.

Step 4) Finally, the luma prediction refinement ΔI(i, j) is added to the subblock prediction I(i, j). The final prediction I′ is generated as the following equation.

I′(i,j)=1(i,j)+ΔI(i,j) (2-17)

PROF is not be applied in two cases for an affine coded CU: 1) all control point MVs are the same, which indicates the CU only has translational motion; 2) the affine motion parameters are greater than a specified limit because the subblock based affine MC is degraded to CU based MC to avoid large memory access bandwidth requirement.

A fast encoding method is applied to reduce the encoding complexity of affine motion estimation with PROF. PROF is not applied at affine motion estimation stage in following two situations: a) if this CU is not the root block and its parent block does not select the affine mode as its best mode, PROF is not applied since the possibility for current CU to select the affine mode as best mode is low; b) if the magnitude of four affine parameters (C, D, E, F) are all smaller than a predefined threshold and the current picture is not a low delay picture, PROF is not applied because the improvement introduced by PROF is small for this case. In this way, the affine motion estimation with PROF can be accelerated.

2.10. Subblock-Based Temporal Motion Vector Prediction (SbTMVP)

VVC supports the subblock-based temporal motion vector prediction (SbTMVP) method. Similar to the temporal motion vector prediction (TMVP) in HEVC, SbTMVP uses the motion field in the collocated picture to improve motion vector prediction and merge mode for CUs in the current picture. The same collocated picture used by TMVP is used for SbTVMP. SbTMVP differs from TMVP in the following two main aspects:
TMVP predicts motion at CU level, but SbTMVP predicts motion at sub-CU level;
Whereas TMVP fetches the temporal motion vectors from the collocated block in the collocated picture (the collocated block is the bottom-right or center block relative to the current CU), SbTMVP applies a motion shift before fetching the temporal motion information from the collocated picture, where the motion shift is obtained from the motion vector from one of the spatial neighboring blocks of the current CU.

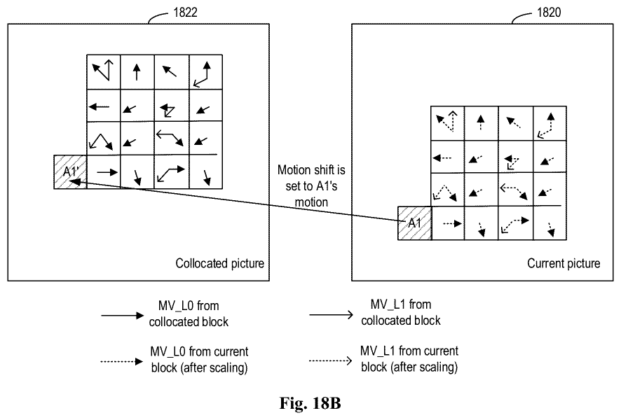

The SbTVMP process is illustrated in FIGS. 18A and 18B. FIG. 18A illustrates a schematic diagram 1810 of spatial neighboring blocks used by SbTMVP. SbTMVP predicts the motion vectors of the sub-CUs within the current CU in two steps. SbTMVP predicts the motion vectors of the sub-CUs within the current CU in two steps. In the first step, the spatial neighbor A1 in FIG. 18A is examined. If A1 has a motion vector that uses the collocated picture as its reference picture, this motion vector is selected to be the motion shift to be applied. If no such motion is identified, then the motion shift is set to (0, 0).

FIG. 18B illustrates a schematic diagram of driving sub-CU motion field by applying a motion shift from spatial neighbor and scaling the motion information from the corresponding collocated sub-CUs. In the second step, the motion shift identified in Step 1 is applied (i.e. added to the coordinates of the current block in the current picture 1820) to obtain sub-CU-level motion information (motion vectors and reference indices) from the collocated picture 1822 as shown in FIG. 18B. The example in FIG. 18B assumes the motion shift is set to block A1's motion. Then, for each sub-CU, the motion information of its corresponding block (the smallest motion grid that covers the center sample) in the collocated picture 1822 is used to derive the motion information for the sub-CU. After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU.

In VVC, a combined subblock based merge list which contains both SbTVMP candidate and affine merge candidates is used for the signalling of subblock based merge mode. The SbTVMP mode is enabled/disabled by a sequence parameter set (SPS) flag. If the SbTMVP mode is enabled, the SbTMVP predictor is added as the first entry of the list of subblock based merge candidates, and followed by the affine merge candidates. The size of subblock based merge list is signalled in SPS and the maximum allowed size of the subblock based merge list is 5 in VVC.

The sub-CU size used in SbTMVP is fixed to be 8×8, and as done for affine merge mode, SbTMVP mode is only applicable to the CU with both width and height are larger than or equal to 8.

The encoding logic of the additional SbTMVP merge candidate is the same as for the other merge candidates, that is, for each CU in P or B slice, an additional RD check is performed to decide whether to use the SbTMVP candidate.

2.11. Adaptive Motion Vector Resolution (AMVR)

In HEVC, motion vector differences (MVDs) (between the motion vector and predicted motion vector of a CU) are signalled in units of quarter-luma-sample when use_integer_mv_flag is equal to 0 in the slice header. In VVC, a CU-level adaptive motion vector resolution (AMVR) scheme is introduced. AMVR allows MVD of the CU to be coded in different precision. Dependent on the mode (normal AMVP mode or affine AVMP mode) for the current CU, the MVDs of the current CU can be adaptively selected as follows:
Normal AMVP mode: quarter-luma-sample, half-luma-sample, integer-luma-sample or four-luma-sample.
Affine AMVP mode: quarter-luma-sample, integer-luma-sample or 1/16 luma-sample.

The CU-level MVD resolution indication is conditionally signalled if the current CU has at least one non-zero MVD component. If all MVD components (that is, both horizontal and vertical MVDs for reference list L0 and reference list L1) are zero, quarter-luma-sample MVD resolution is inferred.

For a CU that has at least one non-zero MVD component, a first flag is signalled to indicate whether quarter-luma-sample MVD precision is used for the CU. If the first flag is 0, no further signaling is needed and quarter-luma-sample MVD precision is used for the current CU. Otherwise, a second flag is signalled to indicate half-luma-sample or other MVD precisions (interger or four-luma sample) is used for normal AMVP CU. In the case of half-luma-sample, a 6-tap interpolation filter instead of the default 8-tap interpolation filter is used for the half-luma sample position. Otherwise, a third flag is signalled to indicate whether integer-luma-sample or four-luma-sample MVD precision is used for normal AMVP CU. In the case of affine AMVP CU, the second flag is used to indicate whether integer-luma-sample or 1/16 luma-sample MVD precision is used. In order to ensure the reconstructed MV has the intended precision (quarter-luma-sample, half-luma-sample, integer-luma-sample or four-luma-sample), the motion vector predictors for the CU will be rounded to the same precision as that of the MVD before being added together with the MVD. The motion vector predictors are rounded toward zero (that is, a negative motion vector predictor is rounded toward positive infinity and a positive motion vector predictor is rounded toward negative infinity).

The encoder determines the motion vector resolution for the current CU using RD check. To avoid always performing CU-level RD check four times for each MVD resolution, in VTM11, the RD check of MVD precisions other than quarter-luma-sample is only invoked conditionally. For normal AVMP mode, the RD cost of quarter-luma-sample MVD precision and integer-luma sample MV precision is computed first. Then, the RD cost of integer-luma-sample MVD precision is compared to that of quarter-luma-sample MVD precision to decide whether it is necessary to further check the RD cost of four-luma-sample MVD precision. When the RD cost for quarter-luma-sample MVD precision is much smaller than that of the integer-luma-sample MVD precision, the RD check of four-luma-sample MVD precision is skipped. Then, the check of half-luma-sample MVD precision is skipped if the RD cost of integer-luma-sample MVD precision is significantly larger than the best RD cost of previously tested MVD precisions. For affine AMVP mode, if affine inter mode is not selected after checking rate-distortion costs of affine merge/skip mode, merge/skip mode, quarter-luma-sample MVD precision normal AMVP mode and quarter-luma-sample MVD precision affine AMVP mode, then 1/16 luma-sample MV precision and 1-pel MV precision affine inter modes are not checked. Furthermore, affine parameters obtained in quarter-luma-sample MV precision affine inter mode is used as starting search point in 1/16 luma-sample and quarter-luma-sample MV precision affine inter modes.

2.12. Bi-Prediction with CU-Level Weight (BCW)

In HEVC, the bi-prediction signal is generated by averaging two prediction signals obtained from two different reference pictures and/or using two different motion vectors. In VVC, the bi-prediction mode is extended beyond simple averaging to allow weighted averaging of the two prediction signals.

P_{bi-pred}((8−w)*P₀+w*P₁+4)>>3 (2-18)

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w∈{3,4,5}) are used.
At the encoder, fast search algorithms are applied to find the weight index without significantly increasing the encoder complexity. These algorithms are summarized as follows. For further details readers are referred to the VTM software and document JVET-L0646. When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP was also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and w is inferred to be 4 (i.e. equal weight is applied). For a merge CU, the weight index is inferred from neighbouring blocks based on the merge candidate index. This can be applied to both normal merge mode and inherited affine merge mode. For constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, e.g., equal weight.

2.13. Local Illumination Compensation (LIC)

Local illumination compensation (LIC) is a coding tool to address the issue of local illumination changes between current picture and its temporal reference pictures. The LIC is based on a linear model where a scaling factor and an offset are applied to the reference samples to obtain the prediction samples of a current block. Specifically, the LIC can be mathematically modeled by the following equation:

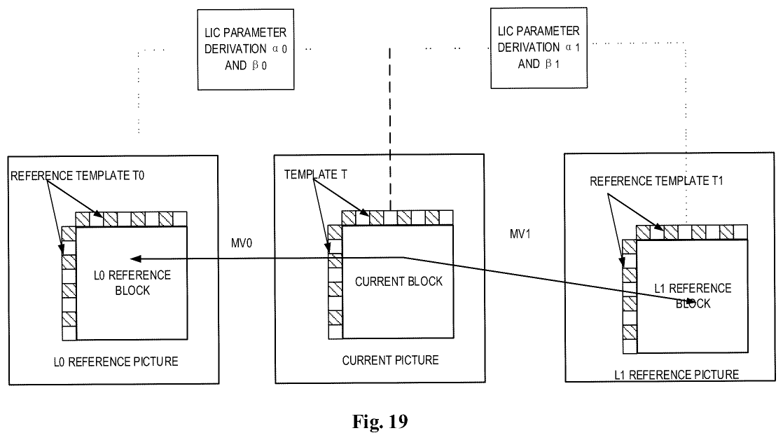

P(x,y)=α·Pᵣ(x+vₓ,y+v_{y})+β

where P(x, y) is the prediction signal of the current block at the coordinate (x, y); Pᵣ(x+vₓ, y+v_{y}) is the reference block pointed by the motion vector (vₓ, v_{y}); α and β are the corresponding scaling factor and offset that are applied to the reference block. FIG. 19 illustrates the LIC process. In FIG. 19, when the LIC is applied for a block, a least mean square error (LMSE) method is employed to derive the values of the LIC parameters (i.e., α and β) by minimizing the difference between the neighboring samples of the current block (i.e., the template T in FIG. 19) and their corresponding reference samples in the temporal reference pictures (i.e., either T0 or T1 in FIG. 19). Additionally, to reduce the computational complexity, both the template samples and the reference template samples are subsampled (adaptive subsampling) to derive the LIC parameters, i.e., only the shaded samples in FIG. 19 are used to derive α and β.

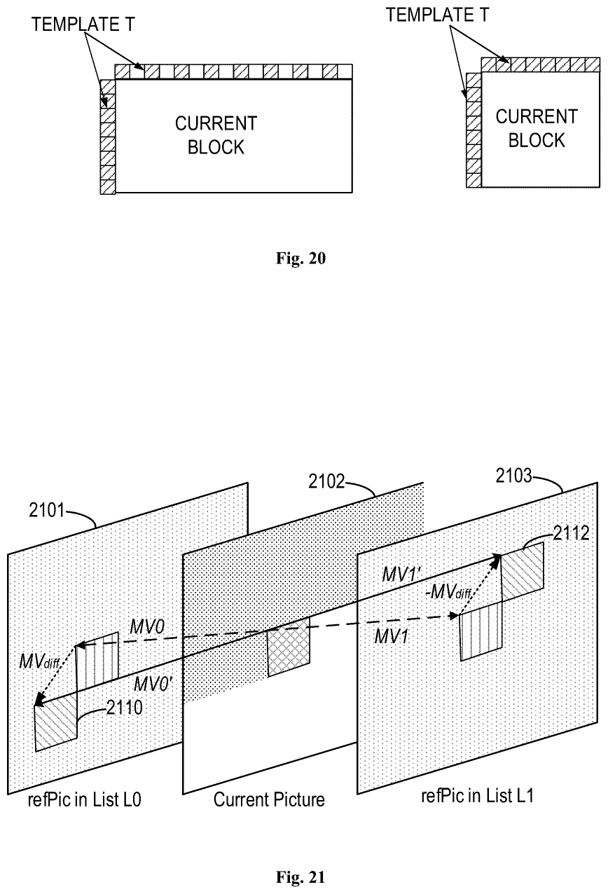

To improve the coding performance, no subsampling for the short side is performed as shown in FIG. 20.

2.14. Decoder Side Motion Vector Refinement (DMVR)

In order to increase the accuracy of the MVs of the merge mode, a bilateral-matching (BM) based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. FIG. 21 is a schematic diagram illustrating the decoding side motion vector refinement. As illustrated in FIG. 21, the SAD between the blocks 2110 and 2112 based on each MV candidate around the initial MV is calculated, where the block 2110 is in a reference picture 2101 in the list L0 and the block 2112 is in a reference picture 2103 in the List L1 for the current picture 2102. The MV candidate with the lowest SAD becomes the refined MV and used to generate the bi-predicted signal.

In VVC, the application of DMVR is restricted and is only applied for the CUs which are coded with following modes and features:
CU level merge mode with bi-prediction MV
One reference picture is in the past and another reference picture is in the future with respect to the current picture
The distances (i.e. POC difference) from two reference pictures to the current picture are same
Both reference pictures are short-term reference pictures
CU has more than 64 luma samples
Both CU height and CU width are larger than or equal to 8 luma samples
BCW weight index indicates equal weight
WP is not enabled for the current block
CIIP mode is not used for the current block

The refined MV derived by DMVR process is used to generate the inter prediction samples and also used in temporal motion vector prediction for future pictures coding. While the original MV is used in deblocking process and also used in spatial motion vector prediction for future CU coding. The additional features of DMVR are mentioned in the following sub-clauses.

2.14.1. Searching Scheme

In DVMR, the search points are surrounding the initial MV and the MV offset obey the MV difference mirroring rule. In other words, any points that are checked by DMVR, denoted by candidate MV pair (MV0, MV1) obey the following two equations:

MV0′=MV0+MV_offset (2-19)

MV1′=MV1−MV_offset (2-20)

Where MV_offset represents the refinement offset between the initial MV and the refined MV in one of the reference pictures. The refinement search range is two integer luma samples from the initial MV. The searching includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form

E(x,y)=A(x−xₘᵢₙ)²+B(y−yₘᵢₙ)²+C (2-21)

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

xₘᵢₙ=(E(−1,0)−E(1,0))/(2(E(−1,0)+E(1,0)−2E(0,0))) (2-22)

yₘᵢₙ=(E(0,−1)−E(0,1))/(2((E(0,−1)+E(0,1)−2E(0,0))) (2-23)

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

2.14.2. Bilinear-Interpolation and Sample Padding

In VVC, the resolution of the MVs is 1/16 luma samples. The samples at the fractional position are interpolated using an 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

2.14.3. Maximum DMVR Processing Unit

When the width and/or height of a CU are larger than 16 luma samples, it will be further split into subblocks with width and/or height equal to 16 luma samples. The maximum unit size for DMVR searching process is limit to 16×16.

2.15. Multi-Pass Decoder-Side Motion Vector Refinement

In this contribution, a multi-pass decoder-side motion vector refinement is applied instead of DMVR. In the first pass, bilateral matching (BM) is applied to a coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

2.15.1. First Pass—Block Based Bilateral Matching MV Refinement

In the first pass, a refined MV is derived by applying BM to a coding block. Similar to decoder-side motion vector refinement (DMVR), the refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.

BM performs local search to derive integer sample precision intDeltaMV and half-pel sample precision halfDeltaMv. The local search applies a 3×3 square search pattern to loop through the search range [−sHor, sHor] in a horizontal direction and [−sVer, sVer] in a vertical direction, wherein, the values of sHor and sVer are determined by the block dimension, and the maximum value of sHor and sVer is 8.

The bilateral matching cost is calculated as: bilCost=mvDistanceCost+sadCost. When the block size cbW*cbH is greater than 64, MRSAD cost function is applied to remove the DC effect of the distortion between the reference blocks. When the bilCost at the center point of the 3×3 search pattern has the minimum cost, the intDeltaMV or halfDeltaMV local search is terminated. Otherwise, the current minimum cost search point becomes the new center point of the 3×3 search pattern and the search for the minimum cost continues, until it reaches the end of the search range.

The conventional fractional sample refinement is further applied to derive the final deltaMV. The refined MVs after the first pass are then derived as:
MV0_pass1=MV0+deltaMV
MV1_pass1=MV1−deltaMV

2.15.2. Second Pass—Subblock Based Bilateral Matching MV Refinement

In the second pass, a refined MV is derived by applying BM to a 16×16 grid subblock. For each subblock, the refined MV is searched around the two MVs (MV0_pass1 and MV1_pass1), obtained on the first pass for the reference picture list L0 and L1. The refined MVs (MV0_pass2(sbIdx2) and MV1_pass2(sbIdx2)) are derived based on the minimum bilateral matching cost between the two reference subblocks in L0 and L1.

For each subblock, BM performs full search to derive integer sample precision intDeltaMV. The full search has a search range [−sHor, sHor] in a horizontal direction and [−sVer, sVer] in a vertical direction, wherein, the values of sHor and sVer are determined by the block dimension, and the maximum value of sHor and sVer is 8.

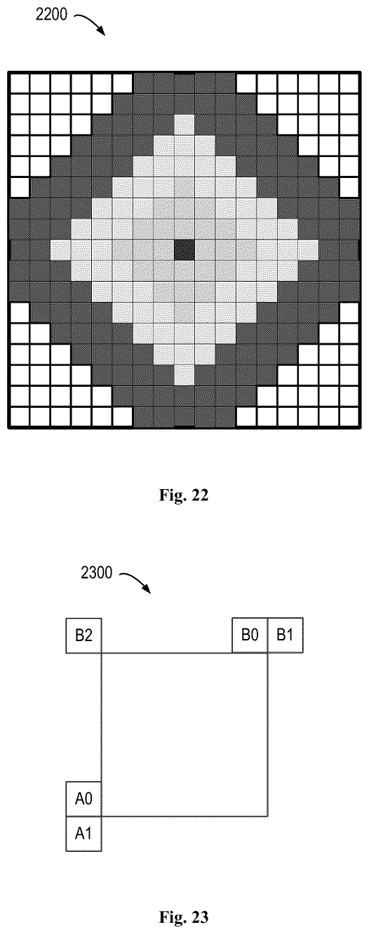

The bilateral matching cost is calculated by applying a cost factor to the SATD cost between the two reference subblocks, as: bilCost=satdCost*costFactor. The search area (2*sHor+1)*(2*sVer+1) is divided up to 5 diamond shape search regions shown in diagram 2200 of FIG. 22. Each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated, otherwise, the int-pel full search continues to the next search region until all search points are examined.

BM performs local search to derive half sample precision halfDeltaMv. The search pattern and cost function are the same as defined in 2.9.1.

The conventional VVC DMVR fractional sample refinement is further applied to derive the final deltaMV(sbIdx2). The refined MVs at second pass is then derived as:
MV0_pass2(sbIdx2)=MV0_pass1+deltaMV(sbIdx2)
MV1_pass2(sbIdx2)=MV1_pass1−deltaMV(sbIdx2)

2.15.3. Third Pass—Subblock Based Bi-Directional Optical Flow MV Refinement

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv(Vx, Vy) is rounded to 1/16 sample precision and clipped between −32 and 32.

The refined MVs (MV0_pass3(sbIdx3) and MV1_pass3(sbIdx3)) at third pass are derived as:
MV0_pass3(sbIdx3)=MV0_pass2(sbIdx2)+bioMv
MV1_pass3(sbIdx3)=MV0_pass2(sbIdx2)−bioMv

2.16. Sample-Based BDOF

In the sample-based BDOF, instead of deriving motion refinement (Vx, Vy) on a block basis, it is performed per sample.

The coding block is divided into 8×8 subblocks. For each subblock, whether to apply BDOF or not is determined by checking the SAD between the two reference subblocks against a threshold. If decided to apply BDOF to a subblock, for every sample in the subblock, a sliding 5×5 window is used and the conventional BDOF process is applied for every sliding window to derive Vx and Vy. The derived motion refinement (Vx, Vy) is applied to adjust the bi-predicted sample value for the center sample of the window.

2.17. Extended Merge Prediction

In VVC, the merge candidate list is constructed by including the following five types of candidates in order:
(1) Spatial MVP from spatial neighbour CUs
(2) Temporal MVP from collocated CUs
(3) History-based MVP from a FIFO table
(4) Pairwise average MVP
(5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

2.17.1. Spatial Candidates Derivation

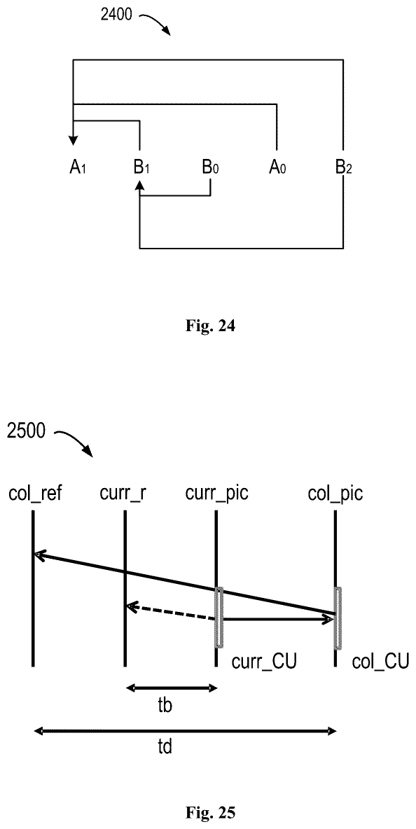

The derivation of spatial merge candidates in VVC is same to that in HEVC except the positions of first two merge candidates are swapped. FIG. 23 is a schematic diagram 2300 illustrating positions of a spatial merge candidate. A maximum of four merge candidates are selected among candidates located in the positions depicted in FIG. 23. The order of derivation is B₀, A₀, B₁, A₁ and B₂. Position B₂ is considered only when one or more than one CUs of position B₀, A₀, B₁, A₁ are not available (e.g. because it belongs to another slice or tile) or is intra coded. After candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. FIG. 24 is a schematic diagram 2400 illustrating candidate pairs considered for redundancy check of spatial merge candidates. Instead only the pairs linked with an arrow in FIG. 24 are considered and a candidate is only added to the list if the corresponding candidate used for redundancy check has not the same motion information.

2.17.2. Temporal Candidates Derivation

In this step, only one candidate is added to the list. Particularly, in the derivation of this temporal merge candidate, a scaled motion vector is derived based on co-located CU belonging to the collocated reference picture. The reference picture list to be used for derivation of the co-located CU is explicitly signalled in the slice header. The scaled motion vector for temporal merge candidate is obtained as illustrated by the dotted line in the diagram 2500 of FIG. 25, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

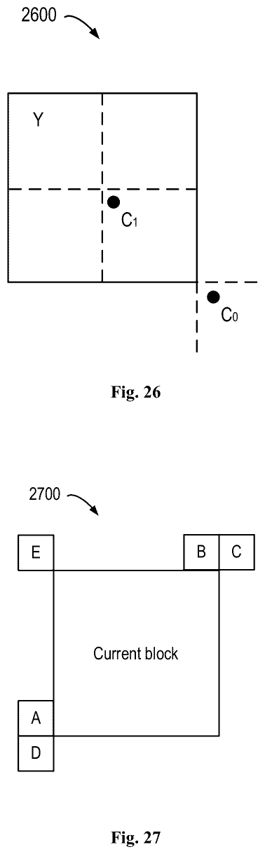

FIG. 26 is a schematic diagram 2600 illustrating candidate positions for temporal merge candidate, C₀ and C₁. The position for the temporal candidate is selected between candidates C₀ and C₁, as depicted in FIG. 26. If CU at position C₀ is not available, is intra coded, or is outside of the current row of CTUs, position C₁ is used. Otherwise, position C₀ is used in the derivation of the temporal merge candidate.

2.17.3. History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 6 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward,

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced: Number of HMPV candidates is used for merge list generation is set as (N<=4)?M:(8−N), wherein N indicates number of existing candidates in the merge list and M indicates number of available HMVP candidates in the table.

Once the total number of available merge candidates reaches the maximally allowed merge candidates minus 1, the merge candidate list construction process from HMVP is terminated.

2.17.4. Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid. When the merge list is not full after pair-wise average merge candidates are added, the zero MVPs are inserted in the end until the maximum merge candidate number is encountered.

2.17.5. Merge Estimation Region

Merge estimation region (MER) allows independent derivation of merge candidate list for the CUs in the same merge estimation region (MER). A candidate block that is within the same MER to the current CU is not included for the generation of the merge candidate list of the current CU. In addition, the updating process for the history-based motion vector predictor candidate list is updated only if (xCb+cbWidth)>>Log 2ParMrgLevel is greater than xCb>>Log 2ParMrgLevel and (yCb+cbHeight)>>Log 2ParMrgLevel is great than (yCb>>Log 2ParMrgLevel) and where (xCb, yCb) is the top-left luma sample position of the current CU in the picture and (cbWidth, cbHeight) is the CU size. The MER size is selected at encoder side and signalled as log 2_parallel_merge_level_minus2 in the sequence parameter set.

2.18. New Merge Candidates

2.18.1. Non-Adjacent Merge Candidates Derivation

FIG. 27 illustrates a schematic diagram 2700 of VVC spatial neighboring blocks of the current block. In VVC, five spatially neighboring blocks shown in FIG. 27 as well as one temporal neighbor are used to derive merge candidates.

It is proposed to derive the additional merge candidates from the positions non-adjacent to the current block using the same pattern as that in VVC. To achieve this, for each search round i, a virtual block is generated based on the current block as follows:

First, the relative position of the virtual block to the current block is calculated by:

Offsetx=−i×gridX,Offsety=−i×gridY

where the Offsetx and Offsety denote the offset of the top-left corner of the virtual block relative to the top-left corner of the current block, gridX and gridY are the width and height of the search grid. Second, the width and height of the virtual block are calculated by:

newWidth=i×2×gridX+currWidth newHeight=i×2×gridY+currHeight.

where the currWidth and currHeight are the width and height of current block. The newWidth and newHeight are the width and height of new virtual block.

gridX and gridY are currently set to currWidth and currHeight, respectively.

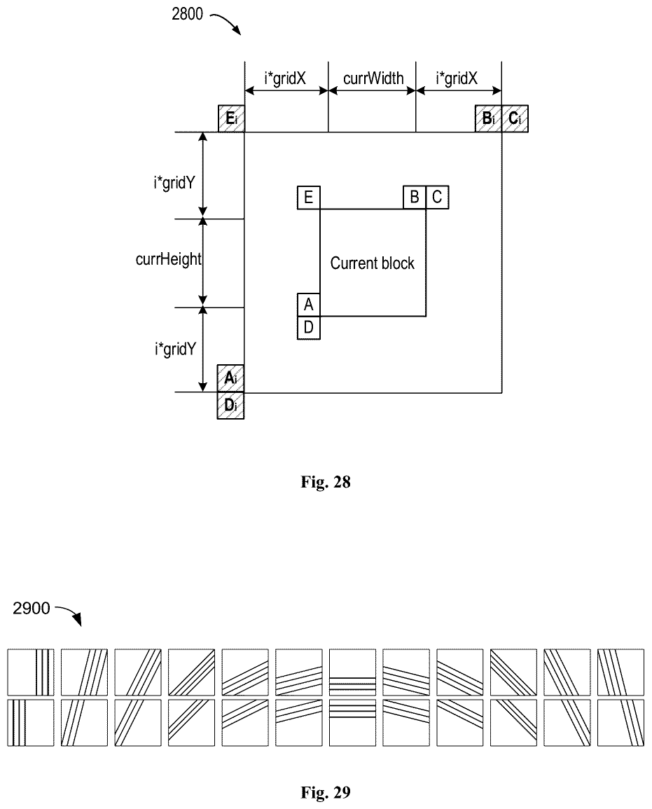

FIG. 28 illustrates a schematic diagram of a virtual block in the ith search round, which shows the relationship between the virtual block and the current block.

After generating the virtual block, the blocks Aᵢ, Bᵢ, Cᵢ, Dᵢ and Eᵢ can be regarded as the VVC spatial neighboring blocks of the virtual block and their positions are obtained with the same pattern as that in VVC. Obviously, the virtual block is the current block if the search round i is 0. In this case, the blocks Aᵢ, Bᵢ, Cᵢ, Dᵢ and Eᵢ are the spatially neighboring blocks that are used in VVC merge mode. When constructing the merge candidate list, the pruning is performed to guarantee each element in merge candidate list to be unique. The maximum search round is set to 1, which means that five non-adjacent spatial neighbor blocks are utilized.

Non-adjacent spatial merge candidates are inserted into the merge list after the temporal merge candidate in the order of B₁->A₁->C₁->D₁->E₁.

2.18.2. STMVP

It is proposed to derive an averaging candidate as STMVP candidate using three spatial merge candidates and one temporal merge candidate.

STMVP is inserted before the above-left spatial merge candidate.

The STMVP candidate is pruned with all the previous merge candidates in the merge list.

For the spatial candidates, the first three candidates in the current merge candidate list are used.

For the temporal candidate, the same position as VTM/HEVC collocated position is used.

For the spatial candidates, the first, second, and third candidates inserted in the current merge candidate list before STMVP are denoted as F, S, and, T.

The temporal candidate with the same position as VTM/HEVC collocated position used in TMVP is denoted as Col.

The motion vector of the STMVP candidate in prediction direction X (denoted as mvLX) is derived as follows:
1) If the reference indices of the four merge candidates are all valid and are all equal to zero in prediction direction X (X=0 or 1),

mvLX=(mvLX_F+mvLX_S+mvLX_T+mvLX_Col)>>2
2) If reference indices of three of the four merge candidates are valid and are equal to zero in prediction direction X (X=0 or 1),

mvLX=(mvLX_F×3+mvLX_S×3+mvLX_Col×2)>>3 or

mvLX=(mvLX_F×3+mvLX_T×3+mvLX_Col×2)>>3 or

mvLX=(mvLX_S×3+mvLX_T×3+mvLX_Col×2)>>3
3) If reference indices of two of the four merge candidates are valid and are equal to zero in prediction direction X (X=0 or 1),

mvLX=(mvLX_F+mvLX_Col)>>1 or

mvLX=(mvLX_S+mvLX_Col)>>1 or

mvLX=(mvLX_T+mvLX_Col)>>1

Note: If the temporal candidate is unavailable, the STMVP mode is off.

2.18.3. Merge List Size

If considering both non-adjacent and STMVP merge candidates, the size of merge list is signalled in sequence parameter set header and the maximum allowed size of merge list is 8.

2.19. Geometric Partitioning Mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, n∈{3 . . . 6} excluding 8×64 and 64×8.

FIG. 29 shows a schematic diagram 2900 of examples of the GPM splits grouped by identical angles. When this mode is used, a CU is split into two parts by a geometrically located straight line (FIG. 29). The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU. The uni-prediction motion for each partition is derived using the process described in 2.19.1.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights as in 2.19.2. This is the prediction signal for the whole CU, and transform and quantization process will be applied to the whole CU as in other prediction modes. Finally, the motion field of a CU predicted using the geometric partition modes is stored as in 2.19.3.

2.19.1. Uni-Prediction Candidate List Construction

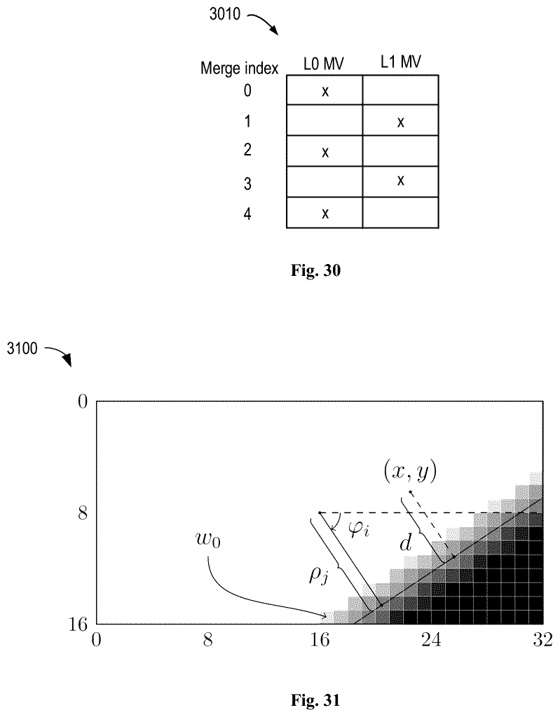

The uni-prediction candidate list is derived directly from the merge candidate list constructed according to the extended merge prediction process in 2.17. FIG. 30 is a schematic diagram illustrating the uni-prediction MV selection for geometric partitioning mode. Denote n as the index of the uni-prediction motion in the geometric uni-prediction candidate list 3010. The LX motion vector of the n-th extended merge candidate, with X equal to the parity of n, is used as the n-th uni-prediction motion vector for geometric partitioning mode. These motion vectors are marked with “x” in FIG. 30. In case a corresponding LX motion vector of the n-the extended merge candidate does not exist, the L(1−X) motion vector of the same candidate is used instead as the uni-prediction motion vector for geometric partitioning mode.

2.19.2. Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

$$d ( x , y ) = ( 2 x + 1 - w ) cos ( {φ}_{1} ) + ( 2 y + 1 - h ) sin ( {φ}_{i} ) - {ρ}_{j} \qquad ( 2 - 24 )$$

$${ρ}_{j} = {ρ}_{x , j} cos ( {φ}_{i} ) + {ρ}_{y , j} sin ( {φ}_{i} ) \qquad ( 2 - 25 )$$

$${ρ}_{x , j} = \{ \begin{matrix}0 & i \%16 = 8 or ( i \%16 \neq 0 and h \geq w ) \\ \pm ( j \times w ) ≫ 2 & otherwise\end{matrix} \qquad ( 2 - 26 )$$

$${ρ}_{y , j} = \{ \begin{matrix}\pm ( j \times h ) ≫ 2 & i \%16 = 8 or ( i \%16 \neq 0 and h \geq w ) \\ 0 & otherwise\end{matrix} \qquad ( 2 - 27 )$$

where i,j are the indices for angle and offset of a geometric partition, which depend on the signaled geometric partition index. The sign of ρ_{x,j} and ρ_{y,j} depend on angle index i.

The weights for each part of a geometric partition are derived as following:

$$wIdxL ( x , y ) = partIdx ? 32 + d ( x , y ) : 32 - d ( x , y ) \qquad ( 2 - 28 )$$

$${w}_{0} ( x , y ) = \frac{C l i p3 ( 0 , 8 , ( wIdxL ( x , y ) + 4 ) ≫ 3 )}{8} \qquad ( 2 - 29 )$$

$${w}_{1} ( x , y ) = 1 - {w}_{0} ( x , y ) \qquad ( 2 - 30 )$$

The partIdx depends on the angle index i. One example of weigh w₀ is illustrated in the diagram 3100 in FIG. 31.

2.19.3. Motion Field Storage for Geometric Partitioning Mode

Mv1 from the first part of the geometric partition, Mv2 from the second part of the geometric partition and a combined My of Mv1 and Mv2 are stored in the motion filed of a geometric partitioning mode coded CU.

The stored motion vector type for each individual position in the motion filed are determined as:

sType=abs(motionIdx)<32?2:(motionIdx<0?(1−partIdx): partIdx) (2-31)

where motionIdx is equal to d(4×+2, 4y+2), which is recalculated from equation (2-18). The partIdx depends on the angle index i.

If sType is equal to 0 or 1, Mv0 or Mv1 are stored in the corresponding motion field, otherwise if sType is equal to 2, a combined My from Mv0 and Mv2 are stored. The combined My are generated using the following process:
1) If Mv1 and Mv2 are from different reference picture lists (one from L0 and the other from L1), then Mv1 and Mv2 are simply combined to form the bi-prediction motion vectors.

Otherwise, if Mv1 and Mv2 are from the same list, only uni-prediction motion Mv2 is stored.

2.20. Multi-Hypothesis Prediction

In multi-hypothesis prediction (MHP), up to two additional predictors are signalled on top of inter AMVP mode, regular merge mode, affine merge and MMVD mode. The resulting overall prediction signal is accumulated iteratively with each additional prediction signal.

pₙ₊₁=(1−αₙ₊₁)pₙ+αₙ₊₁hₙ₊₁

The weighting factor α is specified according to the following Table 2-4:

TABLE 2-4
weighting factor for MHP

| add_hyp_weight_idx | α |
|---|---|
| 0 | ¼ |
| 1 | −⅛ |

For inter AMVP mode, MHP is only applied if non-equal weight in BCW is selected in bi-prediction mode.

The additional hypothesis can be either merge or AMVP mode. In the case of merge mode, the motion information is indicated by a merge index, and the merge candidate list is the same as in the Geometric Partition Mode. In the case of AMVP mode, the reference index, MVP index, and MVD are signaled.

2.21. Non-Adjacent Spatial Candidate

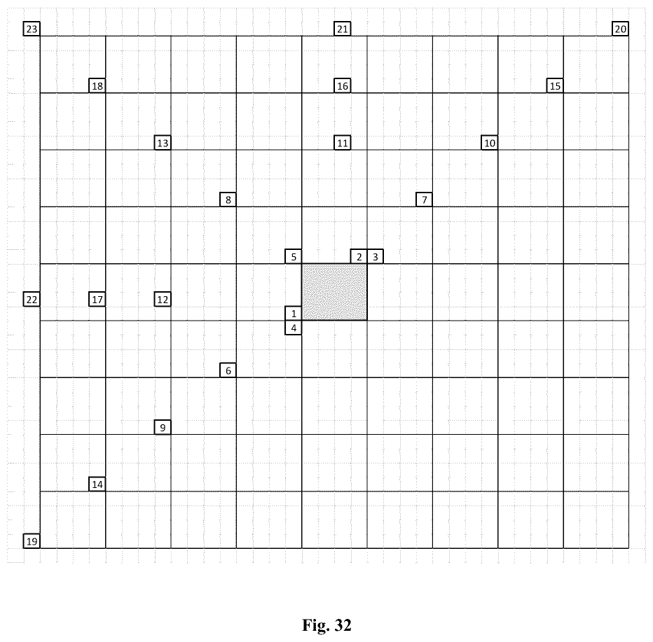

The non-adjacent spatial merge candidates are inserted after the TMVP in the regular merge candidate list. The pattern of the spatial merge candidates is shown on FIG. 32. The distances between the non-adjacent spatial candidates and the current coding block are based on the width and height of the current coding block.

2.22. Template Matching (TM)

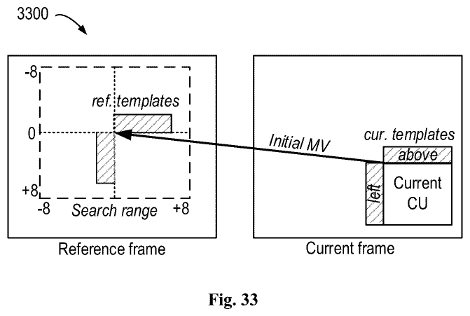

Template matching (TM) is a decoder-side MV derivation method to refine the motion information of the current CU by finding the closest match between a template (i.e., top and/or left neighbouring blocks of the current CU) in the current picture and a block (i.e., same size to the template) in a reference picture. FIG. 33 is a schematic diagram 3300 illustrating the template matching that performs on a search area around initial MV. As illustrated in FIG. 33, a better MV is to be searched around the initial motion of the current CU within a [−8, +8]-pel search range. The template matching that was previously proposed in JVET-J0021 is adopted in this contribution with two modifications: search step size is determined based on AMVR mode and TM can be cascaded with bilateral matching process in merge modes.

In AMVP mode, an MVP candidate is determined based on template matching error to pick up the one which reaches the minimum difference between current block template and reference block template, and then TM performs only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 2-5. This search process ensures that the MVP candidate still keeps the same MV precision as indicated by AMVR mode after TM process.

TABLE 2-5
Search patterns of AMVR and merge mode with AMVR.

| | AMVR mode | | | | Merge mode | |
|---|---|---|---|---|---|---|
| | | | | Quarter- | AltIF = | AltIF = |
| Search pattern | 4-pel | Full-pel | Half-pel | pel | 0 | 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| ⅛-pel cross | | | | | v | |

In merge mode, similar search method is applied to the merge candidate indicated by the merge index. As Table 2-5 shows, TM may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

2.23. Overlapped Block Motion Compensation (OBMC)

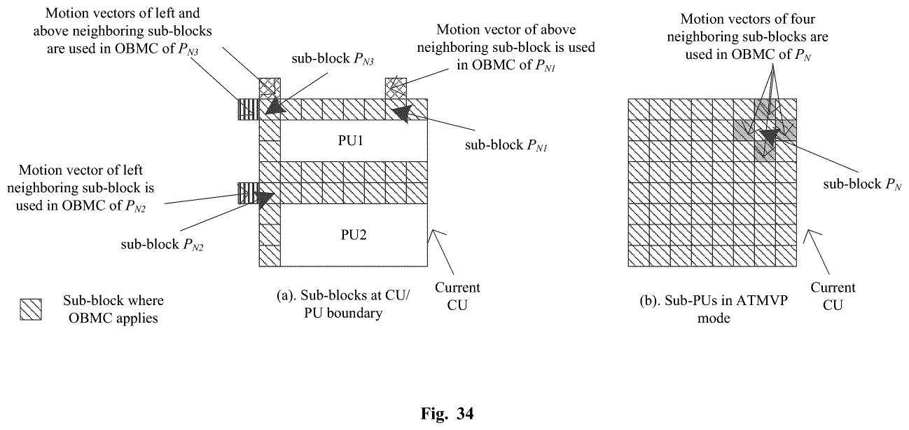

Overlapped Block Motion Compensation (OBMC) has previously been used in H.263. In the JEM, unlike in H.263, OBMC can be switched on and off using syntax at the CU level. When OBMC is used in the JEM, the OBMC is performed for all motion compensation (MC) block boundaries except the right and bottom boundaries of a CU. Moreover, it is applied for both the luma and chroma components. In the JEM, a MC block is corresponding to a coding block. When a CU is coded with sub-CU mode (includes sub-CU merge, affine and FRUC mode), each sub-block of the CU is a MC block. To process CU boundaries in a uniform fashion, OBMC is performed at sub-block level for all MC block boundaries, where sub-block size is set equal to 4×4, as illustrated in FIG. 34.

When OBMC applies to the current sub-block, besides current motion vectors, motion vectors of four connected neighbouring sub-blocks, if available and are not identical to the current motion vector, are also used to derive prediction block for the current sub-block. These multiple prediction blocks based on multiple motion vectors are combined to generate the final prediction signal of the current sub-block.

Prediction block based on motion vectors of a neighbouring sub-block is denoted as P_{N}, with N indicating an index for the neighbouring above, below, left and right sub-blocks and prediction block based on motion vectors of the current sub-block is denoted as P_{C}. When P_{N} is based on the motion information of a neighbouring sub-block that contains the same motion information to the current sub-block, the OBMC is not performed from P_{N}. Otherwise, every sample of P_{N} is added to the same sample in P_{C}, i.e., four rows/columns of P_{N} are added to P_{C}. The weighting factors {¼, ⅛, 1/16, 1/32} are used for P_{N} and the weighting factors {¾, ⅞, 15/16, 31/32} are used for P_{C}. The exception are small MC blocks, (i.e., when height or width of the coding block is equal to 4 or a CU is coded with sub-CU mode), for which only two rows/columns of P_{N} are added to P_{C}. In this case weighting factors {¼, ⅛} are used for P_{N} and weighting factors {¾, ⅞} are used for P_{C}. For P_{N} generated based on motion vectors of vertically (horizontally) neighbouring sub-block, samples in the same row (column) of P_{N} are added to P_{C} with a same weighting factor.

In the JEM, for a CU with size less than or equal to 256 luma samples, a CU level flag is signalled to indicate whether OBMC is applied or not for the current CU. For the CUs with size larger than 256 luma samples or not coded with AMVP mode, OBMC is applied by default. At the encoder, when OBMC is applied for a CU, its impact is taken into account during the motion estimation stage. The prediction signal formed by OBMC using motion information of the top neighbouring block and the left neighbouring block is used to compensate the top and left boundaries of the original signal of the current CU, and then the normal motion estimation process is applied.

2.24. Multiple Transform Selection (MTS) for Core Transform

In addition to DCT-II which has been employed in HEVC, a Multiple Transform Selection (MTS) scheme is used for residual coding both inter and intra coded blocks. It uses multiple selected transforms from the DCT8/DST7. The newly introduced transform matrices are DST-VII and DCT-VIII. Table 2-6 shows the basis functions of the selected DST/DCT.

TABLE 2-6
Transform basis functions of DCT-II/VIII and DSTVII for N-point input

| Transform Type | Basis function Tᵢ(j), i, j = 0, 1, . . . , N − 1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ $where , {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

In order to keep the orthogonality of the transform matrix, the transform matrices are quantized more accurately than the transform matrices in HEVC. To keep the intermediate values of the transformed coefficients within the 16-bit range, after horizontal and after vertical transform, all the coefficients are to have 10-bit.

In order to control MTS scheme, separate enabling flags are specified at SPS level for intra and inter, respectively. When MTS is enabled at SPS, a CU level flag is signalled to indicate whether MTS is applied or not. Here, MTS is applied only for luma. The MTS signaling is skipped when one of the below conditions is applied.
The position of the last significant coefficient for the luma TB is less than 1 (i.e., DC only)
The last significant coefficient of the luma TB is located inside the MTS zero-out region

If MTS CU flag is equal to zero, then DCT2 is applied in both directions. However, if MTS CU flag is equal to one, then two other flags are additionally signalled to indicate the transform type for the horizontal and vertical directions, respectively. Transform and signalling mapping table as shown in Table 2-7. Unified the transform selection for ISP and implicit MTS is used by removing the intra-mode and block-shape dependencies. If current block is ISP mode or if the current block is intra block and both intra and inter explicit MTS is on, then only DST7 is used for both horizontal and vertical transform cores. When it comes to transform matrix precision, 8-bit primary transform cores are used. Therefore, all the transform cores used in HEVC are kept as the same, including 4-point DCT-2 and DST-7, 8-point, 16-point and 32-point DCT-2. Also, other transform cores including 64-point DCT-2, 4-point DCT-8, 8-point, 16-point, 32-point DST-7 and DCT-8, use 8-bit primary transform cores.

TABLE 2-7
Transform and signalling mapping table

| | | | Intra/inter | |
|---|---|---|---|---|
| MTS_CU_flag | MTS_Hor_flag | MTS_Ver_flag | Horizontal | Vertical |
| 0 | | | DCT2 | |
| 1 | 0 | 0 | DST7 | DST7 |
| | 0 | 1 | DCT8 | DST7 |
| | 1 | 0 | DST7 | DCT8 |
| | 1 | 1 | DCT8 | DCT8 |

To reduce the complexity of large size DST-7 and DCT-8, High frequency transform coefficients are zeroed out for the DST-7 and DCT-8 blocks with size (width or height, or both width and height) equal to 32. Only the coefficients within the 16×16 lower-frequency region are retained.

As in HEVC, the residual of a block can be coded with transform skip mode. To avoid the redundancy of syntax coding, the transform skip flag is not signalled when the CU level MTS_CU_flag is not equal to zero. Note that implicit MTS transform is set to DCT2 when LFNST or MIP is activated for the current CU. Also the implicit MTS can be still enabled when MTS is enabled for inter coded blocks.

2.25. Subblock Transform (SBT)

In VTM, subblock transform is introduced for an inter-predicted CU. In this transform mode, only a sub-part of the residual block is coded for the CU. When inter-predicted CU with cu_cbf equal to 1, cu_sbt_flag may be signaled to indicate whether the whole residual block or a sub-part of the residual block is coded. In the former case, inter MTS information is further parsed to determine the transform type of the CU. In the latter case, a part of the residual block is coded with inferred adaptive transform and the other part of the residual block is zeroed out.

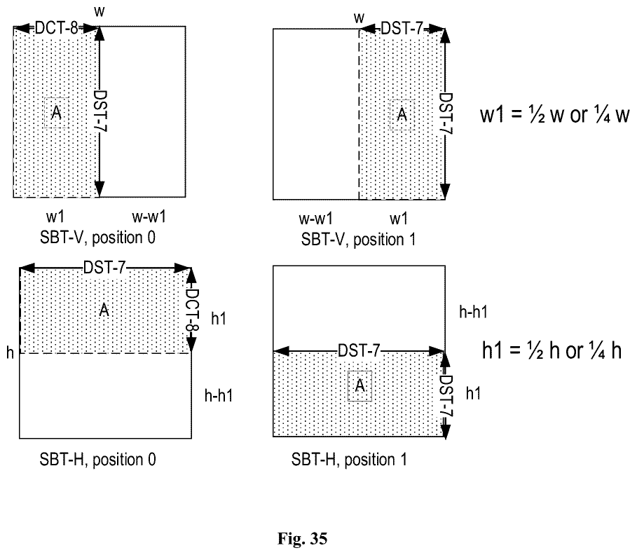

When SBT is used for an inter-coded CU, SBT type and SBT position information are signaled in the bitstream. There are two SBT types and two SBT positions, as indicated in FIG. 35. For SBT-V (or SBT-H), the TU width (or height) may equal to half of the CU width (or height) or ¼ of the CU width (or height), resulting in 2:2 split or 1:3/3:1 split. The 2:2 split is like a binary tree (BT) split while the 1:3/3:1 split is like an asymmetric binary tree (ABT) split. In ABT splitting, only the small region contains the non-zero residual. If one dimension of a CU is 8 in luma samples, the 1:3/3:1 split along that dimension is disallowed. There are at most 8 SBT modes for a CU.

Position-dependent transform core selection is applied on luma transform blocks in SBT-V and SBT-H (chroma TB always using DCT-2). The two positions of SBT-H and SBT-V are associated with different core transforms. More specifically, the horizontal and vertical transforms for each SBT position is specified in FIG. 35. For example, the horizontal and vertical transforms for SBT-V position 0 is DCT-8 and DST-7, respectively. When one side of the residual TU is greater than 32, the transform for both dimensions is set as DCT-2. Therefore, the subblock transform jointly specifies the TU tiling, cbf, and horizontal and vertical core transform type of a residual block.

The SBT is not applied to the CU coded with combined inter-intra mode.

### 3. Problems

In current design of most inter coding tools, the predicted signal for a video unit is obtained using single predicted signal (e.g., uni-prediction or bi-prediction). The coding performance may be improved by considering multiple predicted signals. In addition, although multiple predicted signals are considered in combined inter and intra prediction (CIIP), or geometric partitioning mode (GEO/GPM), or triangle prediction mode (TPM), or multi-hypothesis prediction (MHP), the indication of the additional predicted signals is signalled, which may limit the coding performance.

### 4. Embodiments of the Present Disclosure

Embodiments of the present disclosure below should be considered as examples to explain general concepts. These embodiments should not be interpreted in a narrow way. Furthermore, these embodiments can be combined in any manner.

Fusion means using multiple predicted signals (including a basic predicted signal and one or more additional predicted signal; or including multiple additional predicted signals but without basic predicted signal) to get the final predicted signal for a video unit.

A basic predicted signal may mean the predicted signal derived using the signalled coding information (e.g., merge index for merge mode, or motion vector difference and reference index for AMVP mode). Additional predicted signals may mean the predicted signals used in the fusion method excluding the basic predicted signal.

The final predicted signal may mean the predicted signals used to generate the residue signals at encoder or reconstruction signals at decoder.

In the following discussion, SatShift(x, n) is defined as

$$SatShift ( x , n ) = \{ \begin{matrix}( x + offset 0 ) >> n & ; & x >= 0 \\ - ( ( - x + offset 1 ) >> n & ; & x < 0\end{matrix}$$

In one example, offset0 and/or offset1 are set to (1<<n)>>1 or (1<<(n−1)). In another example, offset0 and/or offset1 are set to 0.

Shift(x, n) is defined as Shift(x, n)=(x+offset0)>>n.

Clip3(x, y, z) is defined as

$$Clip 3 ( x , y , z ) = \{ \begin{matrix}x & ; & z < x \\ y & ; & z > y \\ z & ; & otherwise\end{matrix}$$

$$Abs ( x ) = \{ \begin{matrix}x & ; & x >= 0 \\ - x & ; & x < 0\end{matrix}$$

Whether to and/or how to Derive the Additional Predicted Signal, Fuse the Predicted Signals.
1. It is proposed to get the final predicted signal and/or reconstruction for a non-intra coded video unit coded by fusing multiple predicted signals, wherein the indication of all of the additional predicted signals is derived using coding information rather than signalled in the bitstream.
   a. Alternatively, furthermore, the basic predicted signal is excluded for such a non-intra coded video unit.
   b. In one example, a motion candidate list may be constructed, and the K (e.g., K=2) (e.g., the first K) candidates may be selected to derive the additional predicted signals.
   c. In one example, a motion candidate list may be constructed and re-ordered, and the K (e.g., K=2) (e.g., the first K) candidates in the reordered candidate list may be selected to derive the additional predicted signals.
   d. In one example, a motion candidate list may be constructed and refined (e.g., using template matching), and the K (e.g., K=2) (e.g., the first K) candidates in the reordered candidate list may be selected to derive the additional predicted signals.
2. It is proposed to get the final predicted signal and/or reconstruction for a non-intra coded video unit coded with a non-intra coding tool by fusing multiple predicted signals, wherein the indication of at least one of the additional predicted signals is derived using coding information rather than signalled in the bitstream.
3. In above examples, the additional predicted signal may be derived using the coding information.
   a. In one example, the coding information may refer to motion information.
      i. In one example, the motion information may be those which are used to derive the basic predicted signal.
         1) In one example, the reference index and/or motion vector of, or derived from a 1st motion information used to derive the basic predicted signal may be modified to obtain a 2nd motion information used to derive an additional predicted signal.
         a) In one example, a motion vector difference or delta may be added to the motion vector.
         b) In one example, a reference index offset or delta may be added to the reference index.
         c) In one example, the modification may depend on a template which is consisting of the adjacent and/or non-adjacent neighbouring samples of current video unit.
         °i. In one example, motion vector difference or delta to be used in the modification may be derived using the template.
         °ii. In one example, reference samples of the template may be used to derive the modification.
         2) In one example, a pre-defined/default motion information may be used to derive the additional predicted signal.
         a) In one example, motion vector equals to (mvX0, mvY0) may be used, such as mvX0=0 and mvY0=0.
         b) In one example, reference index for the first reference list and/or the second reference list equals to refX0 and/or refX1 may be used, such as refX0=0 and/or refX1=0.
         3) In one example, the motion information may refer to the motion information of adjacent and/or non-adjacent neighbouring video units.
         a) In one example, the motion information may be derived by averaging the motion information of neighboring video units.
         4) In one example, the motion information may refer to the motion information which is derived according to a certain rule (e.g., the first one in a motion candidate list).
   b. In one example, the coding information may refer to a motion information list (e.g., a merge candidate list, and/or an AMVP list, and/or a GPM merge candidate list, and/or a history motion vector list).
      i. In one example, the additional predicted signal may be derived using one or more motion information in the motion information list except the motion information which is used to derive the basic predicted signal.
         1) In one example, the motion information at a pre-defined position in the motion list may be used, such as the first position, or the last position.
         2) In one example, more than one motion information may be averaged and/or used to derive the additional predicted signal.
         3) In one example, a cost is used to evaluate the difference between each candidate motion information and the 1st motion information which used to derive the basic predicted signal, and the set of motion information with the minimum cost may be used.
         a) In one example, the cost may be calculated using the difference of the motion vectors, and/or the reference indices of the candidate motion information and 2nd motion information.
         4) In one example, the motion information used to get the additional predicted signal may be derived using a template to select one or more motion information from the motion information list.
         a) In one example, the template may refer to a region consisting of the adjacent and/or non-adjacent neighbouring samples.
         b) In one example, the reference of the template may be derived using one motion information of the motion information list, and a cost is calculated between the reference and the reconstruction of the template, and motion information with the minimum cost may be used to get the additional predicted signal.
         °i. In one example, the sum of the absolute transformed difference (SATD) between the predicted samples and the reconstructed samples of the template may be calculated and set as the cost.
         +1. Alternatively, the sum of the squared errors (SSE) may be calculated and set as the cost.
         +2. Alternatively, the sum of the absolute difference (SAD) may be calculated and set as the cost.
         +3. Alternatively, the mean removal sum of the absolute difference (MRSAD) may be calculated and set as the cost.
         +4. Alternatively, a subjective quality metric may be calculated and set as the cost.
         +5. In one example, the structural similarity index measure (SSIM) may be calculated and set as the cost.
         +6. The cost may be calculated in a form of D+lambda×R, wherein D is a metric of distortion such as SAD, SATD, SSE et. al, R represents the number of bits under consideration and lambda is a pre-defined factor.
      ii. In one example, the motion information list may be reordered before used to derive the additional predicted signal.
         a) In one example, template matching base method may be used when reordering the motion information list.
      iii. In one example, a motion vector difference or delta may be added to the motion vector of a list candidate before it is used to derive an additional prediction signal.
   c. In one example, the coding information may refer to the reconstructed pixels/samples/video units adjacent or non-adjacent to current video unit.
      i. In one example, the reconstructed pixels/samples/video units may be used to derive a motion information to get the additional predicted signal.
   d. In one example, the coding information may refer to the basic predicted signal.
      i. In one example, the basic predicted signal may be modified by a process to derive the additional predicted signal.
      ii. In one example, the process may be a filtering method applied to the basic predicted signal.
   e. The coding information may refer to any coding mode information, such as whether the block is affine-coded, and/or whether the block is SbTMVP-coded, and/or subblock-coded, and/or whether the block is LIC-coded, and/or whether the block is CIIP-coded and/or whether the block is BCW-coded, and/or the BCW index of the block, etc.
4. In above examples, the basic predicted signal (P₀) and/or the derived additional predicted signal (P₁) may be fused to get the final predicted signal of the video unit.
   a. In one example, P₀ and P₁ may be weighted to get the final predicted signal, such as P=(w₀×P₀+(1−w₀)×P₁)/2, wherein w₀ is a weighting parameter.
      i. In one example, w₀ may be pre-defined, or derived on the fly, or derived in a look-up table, or signalled in the bitstream.
      ii. In one example, w₀=0.5.
   b. Alternatively, only the derived additional predicted signal may be used to get the final predicted signal.
   c. In one example, P=Shift(w₀×P₀+((1<<K)−w₀)×P₁, K), wherein K is an integer such as 1 or 2. w₀ is an integer<=(1<K).
   d. In one example, P=SatShift(w₀×P₀+(((1<<K)−w₀)−w₀)×P₁, K), wherein K is an integer such as 1 or 2. w₀ is an integer<=(1<K).
   e. In one example, clipping operation may be applied to the basic prediction signal, and/or the additional predicted signal, and/or the final predicted signal.
      i. In one example, Clip3(a, b, P_{xy}) may be used, wherein a and b are integers such as a=0 and b=2\hat{ }B−1, B denotes the bitdepth of the predicted signal, and P_{xy} denotes a sample in the predicted signal P.
5. In above examples, multiple additional predicted signals may be derived. Denote the basic predicted signal as P₀, and the additional predicted signals as P₁ wherein i is in the range of 1 to N, inclusive, wherein N is the number of the additional predicted signals.
   a. In one example, the derivation of the multiple additional predicted signals may be same as the derivation of the predicted signal in bullet 1.b.
   b. In one example, P₀ and P₁ may be weighted to get the final predicted signal, such as P=(w₀×P₀+w₁×P₁+ . . . w_{N}×P_{N}))/(1+N), wherein wᵢ is a weighting parameter.
   c. In one example, N is larger than 1.
   d. In one example, the weights wᵢ may be pre-defined, or derived on the fly, or derived in a look-up table, or signalled in the bitstream.
   e. In one example, the final predicted signal may be derived by iteratively weighted the basic predicted signal and the additional predicted signals.
      i. In one example, P⁽⁰⁾=((1−w1)×P₀+w₁×P₁)/2, P⁽¹⁾=((1−w₂)×P⁽⁰⁾+w₂×P₂)/2, . . . , P^{(N-1)}=((1−w_{N})×P^{(N-2)}+w_{N}×P_{N})/2.
   f. In one example, P=Shift(w₀×P₀+w₁×P₁+ . . . w_{N}×P_{N}, K), wherein K is an integer such as 1 or 2.
      1) For example, w₀+w₁+ . . . w_{N}=(1<<K).
6. In above examples, the determination of using the basic predicted signal or the fused predicted signal as the final predicted signal of the video unit may depend on coding information.
   a. In one example, a cost C may be calculated using the coding information and whether to use the fused predicted signal may depend on C.
      i. In one example, when C is less than or equal to T, the fused predicted signal is used; otherwise, the basic predicted signal is used, wherein T is a threshold.
      ii. Alternatively, when C is larger than or equal to T, the fused predicted signal is used; otherwise, the basic predicted signal is used, wherein T is a threshold.
      iii. In one example, the calculation of the cost may depend on a template, and/or coding information (e.g., the motion information used to get the basic predicted signal (e.g., the 1st predicted signal) and/or the motion information used to predict the additional predicted signal (the 2nd predicted signal)).
         1) In one example, a basic template reference signal (e.g., the 1st reference signal) is derived for the template using the motion information which is used to derive the 1st predicted signal, and an additional template reference signal (e.g., the 2nd reference signal) is derived for the template using the motion information which is used to derive the 2nd predicted signal. A fused template reference signal may be derived using the 1st reference signal and the 2nd reference signal same as the way of deriving the fused predicted signal for the video unit.
         2) In one example, a first cost C1 is derived using the 1st reference signal and the reconstructed samples of the template. A second cost C2 is derived using the fused template predicted signal and the reconstructed samples of the template. Whether to use the fused reference signal for current video unit may depend on C1, and/or C2, and/or a function of C1 and C2. Abs(x) denotes the absolute value of x.
         a) In one example, when Abs (C2−C1) is less than T, the fused predicted signal may be used for current video unit; Otherwise, the basic predicted signal may be used.
         b) In one example, when C2 is less than T, the fused predicted signal may be used for current video unit; Otherwise, the basic predicted signal may be used.
         c) In one example, T may depend on C1, and/or C2.
         °i. In one example, T may be equal to s×C1, wherein s is a scale factor, such as s=1.2/1.5/2.0.
   b. In one example, the coding information may refer to coding modes, and/or size, and/or dimensions of current video unit, and/or its adjacent and/or non-adjacent neighbouring video units.
   c. In one example, the coding information may refer to colour components.
      i. In one example, the fusion may be only applied to component X, such as X is Y, and/or Cb, and/or Cr in YCbCr colour format, or, X is G, and/or B, and/or R in RGB colour format.
      ii. In one example, the way of fusing the basic predicted signal and the derived additional predicted signals may be different for different colour components.
7. In above examples, the non-intra coding tool may refer a coding tool with merge mode, in which at least one predicted signal is derived using a merge index signalled in the bitstream, such as regular merge mode, or merge mode with motion vector difference (e.g., MMVD), or combined inter and intra prediction (e.g., CIIP), or geometric prediction mode (e.g., GPM), or triangle prediction mode (e.g., TPM), or subblock merge prediction (e.g., affine merge or SbTMVP), or template matching with merge mode, or affine merge mode with MMVD, or template matching (e.g., TM) with merge mode, or multi-hypothesis merge (e.g., MHP).
8. In above examples, the non-intra coding tool may refer to a coding tool with normal inter prediction mode, in which at least one predicted signal is derived using motion vector or motion vector difference, and/or reference index signalled in the bitstream, such as AMVP mode, or affine AMVP mode, or template matching with AMVP mode.
9. In above examples, when fusion method is applied to the current video unit, a second coding tool may be not enabled for the current video unit.
   a. In one example, the second coding tool may refer to local illumination compensation (e.g., LIC), and/or decoder side motion refinement (e.g., DMVR), and/or multi-pass DMVR, bi-directional optical flow (e.g., BDOF), and/or sample based BDOF, and/or Prediction refinement with optical flow (e.g., PROF), and/or overlapped block motion compensation (e.g., OBMC), and/or adaptive motion vector resolution (e.g., AMVR), and/or half sample interpolation filter, subblock transform (e.g., SBT), and/or multiple transform sets (e.g., MTS), affine prediction, etc.
   b. Alternatively, the non-intra coding tool may be applied to the current video unit even the fusion method is applied to current video unit.

On Signalling of Application of Fusion-Based Methods
10. Whether to and/or how to use the fusion method for a non-intra coding tool or non-intra coding method may be signalled in the bitstream, or may depend on the coding information.
   a. In one example, how to derive the additional predicted signal and/or the number of the additional predicted signals may be signalled.
   b. In one example, how to fuse the basic predicted signal and/or the derived additional signals may be signalled.
      i. The signaling may depend on slice/picture type, and/or the dimension, size of the current video unit and/or its adjacent or non-adjacent neighbouring video units and/or partitioning depth of current video unit.
   c. Whether to use the fusion method may depend on the slice/picture type.
   d. Whether to and how to use the fusion method may depend on the dimension, size of the current video unit and/or its adjacent or non-adjacent neighbouring video units.
   e. Whether to and how to use the fusion method may depend on the partitioning depth of current video unit.
   f. Alternatively, indication of the side information for fusion-based methods (e.g., whether to apply it or how to apply it) may be conditionally signalled.
      i. In one example, the condition may be related to slice/picture type, block dimension, depth, coded mode.

General Claims
11. In above examples, the non-intra coded block may be an inter-coded block, an IBC-coded block, a palette coded block.
   a. In one example, the proposed fusion method may be applied to a video unit coded by intra block copy (e.g., IBC), in which case the motion information refers to block vector.
      i. In one example, the proposed fusion method may be applied to IBC merge mode.
      ii. In one example, the proposed fusion method may be applied to normal IBC mode.
   b. In one example, the proposed fusion method may be applied to a video unit coded by palette mode, in which case the motion information refers to palette table, and/or palette entry, and/or palette predictor.
12. In above examples, the video unit may refer to the video unit may refer to colour component/sub-picture/slice/tile/coding tree unit (CTU)/CTU row/groups of CTU/coding unit (CU)/prediction unit (PU)/transform unit (TU)/coding tree block (CTB)/coding block (CB)/prediction block(PB)/transform block (TB)/a block/sub-block of a block/sub-region within a block/any other region that contains more than one sample or pixel.
13. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
14. Whether to and/or how to apply the disclosed methods above may be signalled at PB/TB/CB/PU/TU/CU/VPDU/CTU/CTU row/slice/tile/sub-picture/other kinds of region contains more than one sample or pixel.
15. Whether to and/or how to apply the disclosed methods above may be dependent on coded information, such as block size, colour format, single/dual tree partitioning, colour component, slice/picture type.

Embodiments of the present disclosure are related to fusing multiple predicted signals. As used herein, the terms “video unit” or “coding unit” or “block” used herein may refer to one or more of: a color component, a sub-picture, a slice, a tile, a coding tree unit (CTU), a CTU row, a group of CTUs, a coding unit (CU), a prediction unit (PU), a transform unit (TU), a coding tree block (CTB), a coding block (CB), a prediction block(PB), a transform block (TB), a block, a sub-block of a block, a sub-region within the block, or a region that comprises more than one sample or pixel. A block may be rectangular or non-rectangular.

The terms “a fusion of multiple predicted signals” or “fusing the multiple predicted signals” used herein means using multiple predicted signals (including a basic predicted signal and one or more additional predicted signal; or including multiple additional predicted signals but without basic predicted signal) to get the final predicted signal for a video unit.

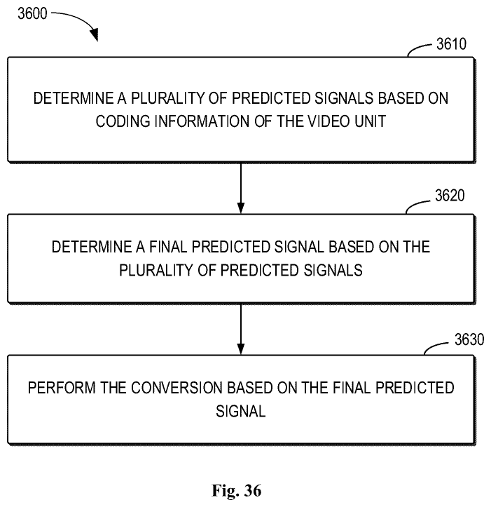

FIG. 36 illustrates a flowchart of a method 3600 for video processing in accordance with some embodiments of the present disclosure. The method 3600 may be implemented during a conversion between a video unit and a bitstream of the video unit.

At block 3610, during a conversion between a video unit of a video and a bitstream of the video unit, a plurality of predicted signals is determined based on coding information of the video unit. The video unit is coded with a non-intra coding mode. In other words, the video unit can be a non-intra coded video unit.

The plurality of predicted signals comprise at least one of: a basic predicted signal or an additional predicted signal. In some embodiments, the plurality of predicted signals may comprise a basic predicted signal and one or more additional predicted signals. Alternatively, the plurality of predicted signals may comprise multiple additional predicted signals and may not comprise the basic predicted signal. The term “basic predicted signal” used herein can refer to the predicted signal derived using the signalled coding information (e.g., merge index for merge mode, or motion vector difference and reference index for AMVP mode). The term “additional predicted signal” used herein can refer to the predicted signal used in the fusion method excluding the basic predicted signal.

At block 3620, a final predicted signal for the video unit is determined based on the plurality of predicted signals. A reconstruction for the video unit is determined based on the plurality of predicted signals. The term “final predicted signal” used herein can refer to the predicted signals used to generate the residue signals at encoder or reconstruction signals at decoder. For example, the final predicted signal may be determined based on a fusion of the plurality of predicted signals.

At block 3630, the conversion is performed based on the final predicted signal for the video unit. In some embodiments, the conversion may comprise encoding the video unit into the bitstream. In some embodiments, the conversion may comprise decoding the video unit from the bitstream.

According to embodiments of the present disclosure, multiple predicted signals are used when determining the final predicted signal. In this way, coding performance can be improved. Compared with the conventional solution, some embodiments of the present disclosure can advantageously improve the coding efficiency.

Implementations of the present disclosure can be described in view of the following clauses, the features of which can be combined in any reasonable manner.

In some embodiments, an indication of all additional predicted signals in the plurality of predicted signals may be derived using the coding information. In some embodiments, the basic predicted signal may be excluded for the video unit.

In some embodiments, a motion candidate list for the video unit may be constructed. In this case, a predetermined number of candidates may be selected from the motion candidate list. Moreover, additional predicted signals in the plurality of predicted signals may be derived based on the selected candidates. For example, a motion candidate list may be constructed, and the K (e.g., K=2) (e.g., the first K) candidates may be selected to derive the additional predicted signals.

Alternatively, a motion candidate list for the video unit may be constructed and the motion candidate list may be reordered. In this case, a predetermined number of candidates may be selected from the reordered motion candidate list. Moreover, additional predicted signals in the plurality of predicted signals may be derived based on the selected candidates. For example, a motion candidate list may be constructed and re-ordered, and the K (e.g., K=2) (e.g., the first K) candidates in the reordered candidate list may be selected to derive the additional predicted signals.

In some other embodiments, a motion candidate list for the video unit may be constructed and the motion candidate list may be refined. In this case, a predetermined number of candidates may be selected from the refined motion candidate list. Moreover, additional predicted signals in the plurality of predicted signals may be derived based on the selected candidates. For example, a motion candidate list may be constructed and refined (e.g., using template matching), and the K (e.g., K=2) (e.g., the first K) candidates in the refined candidate list may be selected to derive the additional predicted signals.

In some embodiments, an indication of at least one additional predicted signal in the plurality of predicted signals may be derived using the coding information. For example, the final predicted signal and/or reconstruction for a non-intra coded video unit coded with a non-intra coding tool may be obtained by fusing multiple predicted signals, and the indication of at least one of the additional predicted signals may be derived using coding information rather than indicated in the bitstream.

In some embodiments, the additional predicted signal in the plurality of predicted signals may be derived using the coding information. In some embodiments, the coding information may comprise motion information associated with the video unit. For example, the motion information may be used to derive the basic predicated signal for the video unit. In on example embodiment, a modification may be applied to at least one of the followings to obtain second motion information: a reference index derived from first motion information which is used to derive the basic predicted signal, or a motion vector derived from the first motion information. The second motion information may be used to derive the additional predicted signal in the plurality of predicted signals. For example, the reference index and/or motion vector of, or derived from a 1st motion information used to derive the basic predicted signal may be modified to obtain a 2nd motion information used to derive an additional predicted signal.

In some embodiments, a motion vector difference or delta may be added to the motion vector. Alternatively, or in addition, a reference index offset or delta may be added to the reference index.

In some embodiments, the modification may depend on a template which comprises at least one of: an adjacent neighboring sample of the video unit or a non-adjacent neighboring sample of the video unit. In this case, in some embodiments, a motion vector difference used in the modification may be derived using the template. In some other embodiments, a set of reference samples of the template may be used to derive the modification.

In some embodiments, the additional predicted signal in the plurality of predicted signals may be derived using predefined motion information. In other words, a pre-defined/default motion information may be used to derive the additional predicted signal. In one example embodiment, predefined motion vectors may be used to derive the additional predicted signal. For example, motion vector equals to (mvX0, mvY0) may be used, such as mvX0=0 and mvY0=0. Alternatively, or in addition, a predefined index for at least one of: a first reference list or a second reference list may be used to derive the additional predicted signal. For example, reference index for the first reference list and/or the second reference list equals to refX0 and/or refX1 may be used, such as refX0=0 and/or refX1=0.

In some other embodiments, the motion information may comprise motion information of one or more neighboring video units, and the one or more neighboring video units may comprise at least one of: an adjacent neighboring video unit or a non-adjacent neighboring video unit. In one example embodiment, the motion information may be derived by averaging the motion information of the one or more neighboring video units. Alternatively, or in addition, the motion information may be derived according to a predefined rule. For example, the predefined rule may be the first one in a motion candidate list. In other words, the motion information may be the first one in the motion candidate list.

In some embodiments, the coding information may comprise a motion information list. For example, the motion information list may comprise one or more of: a merge candidate list, an AMVP list, a GPM merge candidate list, or a history motion vector list. In one example embodiment, the additional predicted signal in the plurality of predicted signals may be derived using at least one motion information in the motion information list except a motion information used to derive the basic predicted signal of the video unit. For example, a target motion information at a predefined position (such as, the first position or the last position) in the motion information list may be used to derive the additional predicted signal. In some embodiments, more than one motion information may be averaged and used to derive the additional predicted signal. In some embodiments, a cost may be used to evaluate a difference between each candidate motion information and first motion information used to derive the basic predicted signal. In this case, a set of motion information with a minimum cost may be used to derive the additional predicted signal. In some embodiments, the cost may be calculated using at least one of: differences of motion vectors, or reference indexes of candidate motion information and second motion information.

Alternatively, or in addition, motion information used to obtain the additional predicted signal may be derived using a template to select one or more motion information from the motion information list. For example, the template may comprise a region which comprises at least one of: an adjacent neighboring sample or a non-adjacent neighboring sample. In some embodiments, a reference of the template may be derived using one motion information of the motion information list. In this case, a cost may be calculated between the reference and a reconstruction of the template. Moreover, motion information with a minimum cost may be used to obtain the additional predicted signal.

In some embodiments, a sum of absolute transformed difference (SATD) between predicted samples of the template and reconstructed samples of the template may be calculated and set as the cost. For example, a sum of squared errors between predicted samples of the template and reconstructed samples of the template may be calculated and set as the cost. Alternatively, a sum of absolute difference (SAD) may be calculated and set as the cost. In some embodiments, a mean removal sum of absolute difference (MRSAD) may be calculated and set as the cost. In some other embodiments, a subjective quality metric may be calculated and set as the cost. In some embodiments, a structural similarity index measure (SSIM) may be calculated and set as the cost. Alternatively, or in addition, the cost may be calculated in a form of D+λR, where D represents a metric of distortion (such as, SAD, SATD, SSE or the like), R represents the number of bits under consideration and X represents a pre-defined factor.

In some embodiments, the motion information list may be reordered before the motion information list is used to derive the additional predicted signal in the plurality of predicted signals. For example, a template matching base method may be applied when reordering the motion information list. In some other embodiments, a motion vector difference may be added to a motion vector of the motion information list before the motion information list is used to derive the additional prediction signal.

In some embodiments, the coding information may comprise one or more of: a reconstructed pixel adjacent to the video unit, a reconstructed pixel non-adjacent to the video unit, a reconstructed sample adjacent to the video unit, a reconstructed sample non-adjacent to the video unit, a reconstructed video unit adjacent to the video unit, or a reconstructed video unit non-adjacent to the video unit. For example, at least one of the followings may be used to derive a motion information to obtain the additional predicted signal of the video unit: a reconstructed pixel adjacent to the video unit, a reconstructed pixel non-adjacent to the video unit, a reconstructed sample adjacent to the video unit, a reconstructed sample non-adjacent to the video unit, a reconstructed video unit adjacent to the video unit, or a reconstructed video unit non-adjacent to the video unit.

In some embodiments, the coding information comprises the basic predicated signal for the video unit. For example, in some embodiments, the basic predicted signal may be modified by a process to derive an additional predicted signal of the video unit. Alternatively, or in addition, the process may be a filtering method applied to the basic predicted signal.

In some embodiments, the coding information may refer to any coding mode information. For example, the coding information may indicate one or more of: whether the video unit is affine-coded, whether the video unit is subblock-based temporal motion vector prediction (SbTMVP)-coded, whether the video unit is subblock-coded, whether the video unit is local illumination compensation (LIC)-coded, whether the video unit is combined inter and intra prediction (CIIP)-coded, whether the video unit is bi-prediction with coding unit level weight (BCW)-coded, or a BCW index of the video unit.

In some embodiments, at least one of: the basic predicted signal of the video unit and the additional predicted signal of the video unit may be fused to obtain the final predicted signal of the video unit. In some embodiments, the basic predicted signal and the additional predicted signal may be weighted to obtain the final predicted signal. For example, the final predicted signal may be obtained by: P=(w₀×P₀+(1−w₀)×P₁)/2, where P represents the final predicted signal, w₀ represents a weighting parameter, P₀ represents the basic predicted signal, and P₁ represents the additional predicted signal. In some embodiments, the weighting parameter may be predefined. Alternatively, the weighting parameter may be derived on the fly. In some other embodiments, the weighting parameter may be derived in a look-up table. In a further embodiment, the weighting parameter may be indicated in the bitstream. For example, in some embodiments, the weighting parameter may be 0.5. In some embodiments, only the additional predicted signal may be used to obtain the final predicted signal.

In some embodiments, the final predicted signal may be obtained by: P=Shift(w₀×P₀+((1<<K)−w₀)×P₁, K), where K represents an integer (such as 1 or 2), w₀ represents an integer which is not larger than (1<<K), and Shift presents an operation. In this case, in some embodiments, the operation Shift (x, n) may be defined as Shift(x, n)=(x+offset0)>>n, where x, n and offset 0 represent variables, respectively.

Alternatively, or in addition, the final predicted signal may be obtained by: P=SatShift (w₀×P₀+((1<<K)−w₀)×P₁, K), where K represents an integer (such as 1 or 2), w₀ represents an integer which is not larger than (1<<K), and SatShift presents an operation. In this case, in some embodiments, the operation SatShift (x, n) may be defined as

$$SatShift ( x , n ) = \{ \begin{matrix}( x + offset 0 ) >> n & ; & x >= 0 \\ - ( ( - x + offset 1 ) >> n & ; & x < 0\end{matrix} ,$$

where x and n represent variables, respectively, and where offset0 and/or offset1 are set to (1<<n)>>1 or (1<<(n−1)), or offset0 and/or offset1 are set to 0.

In some embodiments, a clipping operation may be applied to at least one of: the basic prediction signal, the additional predicted signal, or the final predicted signal. In this case, in some embodiments, the clipping operation may be Clip3(a, b, Pxy), where a represents an integer, b is denoted as 2\hat{ }B−1, B denotes a bit-depth of a predicted signal, Pxy represents a sample in the predicted signal. In some embodiments, Clip3(x, y, z) may be defined as:

$$Clip 3 ( x , y , z ) = \{ \begin{matrix}x & ; & z < x \\ y & ; & z > y \\ z & ; & otherwise\end{matrix} .$$

In some embodiments, the plurality of predicted signals may comprise multiple additional predicted signals. For example, in some embodiments, the multiple additional predicted signals may be derived based on a predetermined number of candidates in a motion candidate list which is constructed for the video unit.

In some embodiments, the basic predicted signal and the multiple additional predicted signals may be weighted to obtain the final predicted signal of the video unit. For example, the final predicted signal may be obtained by: P=(w₀P₀+ . . . +w₁P₁+ . . . +w_{N} P_{N}))/(1+N), where P represents the final predicted signal, P₀ represents the basic predicted signal, P₁ represents the i-th additional predicted signal in the multiple additional predicted signals, i is in a range from 1 to N, N represents the number of additional predicted signals, w₀ represents a weighting parameter for the basic predicted signal, wᵢ represents a weighting parameter for the i-th additional predicted signal, and w_{N} represents a weighting parameter for the n-th additional predicated signal. In some embodiments, N may be larger than 1. In some embodiments, the weighting parameter may be predefined. Alternatively, the weighting parameter may be derived on the fly. In some other embodiments, the weighting parameter may be derived in a look-up table. In a further embodiment, the weighting parameter may be indicated in the bitstream.

Alternatively, or in addition, the final predicted signal of the video unit may be derived by iteratively weighted the basic predicted signal and the multiple additional predicted signals. In some embodiments, the final predicted signal after i iterations may be obtained by: P⁽ⁱ⁻¹⁾=((1−wᵢ)×P⁽ⁱ⁻²⁾+wᵢ×Pᵢ)/2, where P⁽ⁱ⁻¹⁾ represents the final predicted signal after i iterations, P⁽ⁱ⁻²⁾ represents the final predicted signal after (i−1) iterations, i is in a range from 1 to N, N represents the number of additional predicted signals, and wᵢ represents a weighting parameter for the i-th additional predicted signal, and the final predicted signal after the first iteration may be obtained by: P⁽⁰⁾=((1−w₁)×P₀+w₁×P₁)/2, and where P⁽⁰⁾ represents the final predicted signal after the first iteration, P₀ represents the basic predicted signal, P₁ represents the first additional predicted signal, and w₁ represents a weighting parameter for the first additional predicted signal. In other words, in one example, P⁽⁰⁾=((1−w₁)×P₀+w₁×P₁)/2, P⁽¹⁾=((1−w₂)×P⁽⁰⁾+w₂×P₂)/2, . . . P^{(N-1)}=((1−w_{N})×P^{(N-2)}+w_{N}×P_{N})/2.

In some other embodiments, the final predicted signal of the video unit may be obtained by: P=Shift(w₀×P₀+w₁×P₁+ . . . w_{N}×P^{N}, K), where P represents the final predicted signal, w₀ represents a weighting parameter for the basic predicted signal, P₀ represents the basic predicted signal, w₁ represents a weighting parameter for the first additional predicted signal, P₁ represents the first additional predicted signal, w_{N} represents a weighting parameter for the N-th additional predicted signal, P_{N} represents the N-the additional predicted signal, K is an integer, shift represents an operation. For example, in some embodiments, w0+w1+ . . . w_{N}−(1<<K).

In some embodiments, whether to use the basic predicted signal or a fusion of the plurality of predicted signals as the final predicted signal may be determined based on the coding information. In an example embodiment, a cost may be calculated based on the coding information. In this case, whether to use the fusion of the plurality of predicted signals may be based on the cost. For example, in some embodiments, if the cost is less than or equals to a first threshold, the fusion of the plurality of predicted signals may be used. Otherwise, if the cost is larger than the first threshold, the basic predicted signal may be used. Alternatively, if the cost is larger than or equals to a second threshold, the fusion of the plurality of predicted signals may be used. Otherwise, if the cost is less than the second threshold, the basic predicted signal may be used.

In some embodiments, the cost may be calculated based on at least one of: a template, the coding information used to obtain the basic predicted signal, or motion information used to obtain the additional predicted signal. In one example, the calculation of the cost may depend on a template, and/or coding information (e.g., the motion information used to get the basic predicted signal (e.g., the 1st predicted signal) and/or the motion information used to predict the additional predicted signal (the 2^{nd} predicted signal)).

In some embodiments, a basic template reference signal (for example, the first reference signal) may be derived for a first template using first motion information which is used to derive the basic predicted signal. In addition, an additional template reference signal (the second reference signal) may be derived for a second template using second motion information which is used to derive the additional predicted signal. In this case, a fused template reference signal may be derived using the same way as the derivation of a fused signal using the basic predicted signal and the additional predicted signal.

In some embodiments, a first cost (represented as C1) may be derived using the basic template reference signal and a reconstructed sample of the template. In addition, a second cost(represented as C2) may be derived using a fused template predicted signal and the reconstructed sample of the template. In this case, whether to use the fusion of the plurality of predicted signals for the video unit may be determined based on at least one of: the first cost, the second cost, or a fusion of the first and second costs.

In some embodiments, if an absolute value of a difference between the second cost and the first cost (for example, Abs(C2−C1)) is less than a third threshold, the plurality of predicted signals may be used for the video unit. Otherwise, if the absolute value is not less than the third threshold, the basic predicted signal may be used for the video unit. In some other embodiments, if the second cost is less than a third threshold, the plurality of predicted signals may be used for the video unit. Otherwise, if the second cost is not less than the third threshold, the basic predicted signal may be used for the video unit. In some embodiments, the third threshold may be based on at least one of: the first cost or the second cost. For example, in some embodiments, the third threshold may equal to s*the first cost, where s represents a scaling factor.

In some embodiments, the coding information may comprise at least one of: a coding mode, a size of the video unit, a dimension of the video unit, an adjacent neighboring video unit of the video unit, a non-adjacent neighboring video unit of the video unit, or colour components.

In one example, the plurality of predicted signals may be applied to component X, and the component X is at least one of: Y, Cb, or Cr in YCbCr colour formant, or G, B, or R in red-green-blue (RGB) format. In other words, the fusion may be only applied to component X, such as X is Y, and/or Cb, and/or Cr in YCbCr colour format, or, X is G, and/or B, and/or R in RGB colour format. In some other embodiments, a fusion of the basic predicted signal and multiple additional predicted signals may be different for different colour components.

In some embodiments, the non-intra coding mode may comprise a coding tool with merge mode in which at least one predicted signal is derived using a merge index indicated in the bitstream. For example, the coding tool with merge mode may comprise one or more of: a regular merge mode, a merge mode with motion vector difference (MMVD), a combined inter and intra prediction (CIIP), a geometric prediction mode (GPM), a triangle prediction mode (TPM), a subblock merge prediction, a template matching with merge mode, an affine merge mode with MMVD, a template matching (TM) with merge mode, or a multi-hypothesis merge (MHP).

In some other embodiments, the non-intra coding mode may comprise a coding tool with normal inter prediction mode in which at least one predicted signal is derived using at least one of: a motion vector or a motion vector difference, or a reference index indicated in the bitstream. For example, the coding tool with normal inter prediction mode may comprise one or more of: an advance motion vector perdition (AMVP) mode, an affine AMVP mode, or a template matching with AMVP mode.

In some embodiments, if a fusion of the plurality of predicted signals is applied, a target coding tool may not be enabled for the video unit. For example, the target coding tool may comprise at least one of: a local illumination compensation (LIC), a decoder side motion refinement (DMVR), a multi-pass DMVR, a bi-directional optical flow (BDOF), a sample based BDOF, a prediction refinement with optical flow (PROF), an overlapped block motion compensation (OBMC), an adaptive motion vector resolution (AMVR), a half sample interpolation filter, a subblock transform (SBT), a multiple transform set (MTS), or an affine prediction. Alternatively, a non-intra coding tool may be applied to the video unit even a fusion of the plurality of predicted signals is applied to the video unit.

In some embodiments, whether to use a fusion of the plurality of predicted signals for a non-intra coding tool may be determined based on the coding information. Alternatively, or in addition, how to use the fusion of the plurality of predicted signals for the non-intra coding tool may be determined based on the coding information. For example, in some embodiments, whether to use a fusion of the plurality of predicted signals for a non-intra coding tool may be indicated in the bitstream. Alternatively, or in addition, how to use the fusion of the plurality of predicted signals for the non-intra coding tool may be indicated in the bitstream. In some embodiments, one or more of the followings may be indicated: how to derive an additional predicted signal in the plurality of predicted signals, or the number of additional predicted signals in the plurality of predicted signals.

In some embodiments, how to fuse at least one of: a basic predicted signal or an additional predicted signal may be indicated. In this case, for example, an indication of how to fuse at least one of: the basic predicted signal or the additional predicted signal may depend on one or more of: picture type, slice type, a dimension size of the video unit, an adjacent neighboring video unit of the video unit, a non-adjacent neighboring video unit of the video unit, or a partitioning depth of the video unit.

In some embodiments, whether to fuse the plurality of predicted signals may depend on at least one of: slice type or picture type. In some other embodiments, whether to and/or how to fuse the plurality of predicted signals may depend on at least one of: a dimension, a size of the video unit, an adjacent neighboring video unit of the video unit, or a non-adjacent neighboring video unit of the video unit. Alternatively, or in addition, whether to and/or how to fuse the plurality of predicted signals may depend on a partitioning depth of the video unit. In some other embodiments, an indication of dice information for fusing the plurality of predicted signals may be indicated based on a condition. For example, the condition may be related to at least one of: slice type, picture type, block dimension, depth, or coded mode.

In some embodiments, the video unit may comprise one of: an inter-coded block, an intra block copy (IBC) coded block, or a palette coded block. In some other embodiments, if a fusion of the plurality of predicted signals is applied to the video unit which is coded by IBC, motion information of the video unit may comprise a block vector. In some embodiments, the fusion may be applied to IBC merge mode. Alternatively, or in addition, the fusion may be applied to normal IBC mode. In some embodiments, if a fusion of the plurality of predicted signals is applied to the video unit which is coded by palette mode, motion information of the video unit may comprise one or more of: a palette table, a palette entry, or a palette predictor.

In some embodiments, an indication of whether to and/or how to determine the final predicted based on the plurality of predicted signals may be indicated at one of the followings: sequence level, group of pictures level, picture level, slice level, or tile group level. In some embodiments, an indication of whether to and/or how to apply the coding tool may be indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, an indication of whether to and/or how to determine the final predicted based on the plurality of predicted signals may be included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, whether to and/or how to determine the final predicted based on the plurality of predicted signals may be determined based on coded information of the target block. The coded information may include at least one of: a block size, a colour format, a single and/or dual tree partitioning, a colour component, a slice type, or a picture type.

In some embodiments, a bitstream of a video may be stored in a non-transitory computer-readable recording medium. The bitstream of the video can be generated by a method performed by a video processing apparatus. According to the method, a plurality of predicted signals may be determined based on coding information of a video unit. The video unit may be coded with a non-intra coding mode. The plurality predicted signals may comprise at least one of: a basic predicted signal or an additional predicted signa. A final predicted signal for the video unit may be determined based on the plurality of predicted signals. A bitstream of the target block may be generated based on the final predicted signal for the video unit.

In some embodiments, a plurality of predicted signals may be determined based on coding information of a video unit. The video unit may be coded with a non-intra coding mode. The plurality predicted signals may comprise at least one of: a basic predicted signal or an additional predicted signa. A final predicted signal for the video unit may be determined based on the plurality of predicted signals. A bitstream of the target block may be generated based on the final predicted signal for the video unit and stored in a non-transitory computer-readable recording medium.

Embodiments of the present disclosure can be implemented separately. Alternatively, embodiments of the present disclosure can be implemented in any proper combinations. Implementations of the present disclosure can be described in view of the following clauses, the features of which can be combined in any reasonable manner.

Clause 1. A method of video processing, comprising: determining, during a conversion between a video unit of a video and a bitstream of the video unit, a plurality of predicted signals based on coding information of the video unit, the video unit being coded with a non-intra coding mode, and the plurality predicted signals comprising at least one of: a basic predicted signal or an additional predicted signal; determining a final predicted signal for the video unit based on the plurality of predicted signals; and performing the conversion based on the final predicted signal for the video unit.

Clause 2. The method of clause 1, wherein an indication of all additional predicted signals in the plurality of predicted signals is derived using the coding information.

Clause 3. The method of clause 1, wherein the basic predicted signal is excluded for the video unit.

Clause 4. The method of clause 1, wherein determining the plurality of predicated signals comprises: constructing a motion candidate list for the video unit; selecting a predetermined number of candidates from the motion candidate list; and deriving additional predicted signals in the plurality of predicted signals based on the selected candidates.

Clause 5. The method of clause 1, wherein determining the plurality of predicated signals comprises: constructing a motion candidate list for the video unit; reordering the motion candidate list; selecting a predetermined number of candidates from the reordered motion candidate list; and deriving additional predicted signals in the plurality of predicted signals based on the selected candidates.

Clause 6. The method of clause 1, wherein determining the plurality of predicated signals comprises: constructing a motion candidate list for the video unit; refining the motion candidate list; selecting a predetermined number of candidates from the refined motion candidate list to derive additional predicted signals in the plurality of predicted signals.

Clause 7. The method of clause 1, wherein an indication of at least one additional predicted signal in the plurality of predicted signals is derived using the coding information.

Clause 8. The method of clause 1, wherein the additional predicted signal in the plurality of predicted signals is derived using the coding information.

Clause 9. The method of clause 1, wherein the coding information comprises motion information associated with the video unit.

Clause 10. The method of clause 9, wherein the motion information is used to derive the basic predicated signal for the video unit.

Clause 11. The method of clause 10, wherein a modification is applied to at least one of the followings to obtain second motion information: a reference index derived from first motion information which is used to derive the basic predicted signal, or a motion vector derived from the first motion information, and wherein the second motion information is used to derive the additional predicted signal in the plurality of predicted signals.

Clause 12. The method of clause 11, wherein a motion vector difference is added to the motion vector.

Clause 13. The method of clause 11, wherein a reference index offset is added to the reference index.

Clause 14. The method of clause 11, wherein the modification depends on a template which comprises at least one of: an adjacent neighboring sample of the video unit or a non-adjacent neighboring sample of the video unit.

Clause 15. The method of clause 14, wherein a motion vector difference used in the modification is derived using the template.

Clause 16. The method of clause 14, wherein a set of reference samples of the template are used to derive the modification.

Clause 17. The method of clause 9, wherein the additional predicted signal in the plurality of predicted signals is derived using predefined motion information.

Clause 18. The method of clause 17, wherein predefined motion vectors are used to derive the additional predicted signal.

Clause 19. The method of clause 17, wherein a predefined index for at least one of: a first reference list or a second reference list is used to derive the additional predicted signal.

Clause 20. The method of clause 9, wherein the motion information comprises motion information of one or more neighboring video units, and the one or more neighboring video units comprise at least one of: an adjacent neighboring video unit or a non-adjacent neighboring video unit.

Clause 21. The method of clause 20, wherein the motion information is derived by averaging the motion information of the one or more neighboring video units.

Clause 22. The method of clause 9, wherein the motion information is derived according to a predefined rule.

Clause 23. The method of clause 1, wherein the coding information comprises a motion information list.

Clause 24. The method of clause 23, wherein the additional predicted signal in the plurality of predicted signals is derived using at least one motion information in the motion information list except a motion information used to derive the basic predicted signal of the video unit.

Clause 25. The method of clause 24, wherein a target motion information at a predefined position in the motion information list is used to derive the additional predicted signal.

Clause 26. The method of clause 24, wherein more than one motion information is averaged and used to derive the additional predicted signal.

Clause 27. The method of clause 24, wherein a cost is used to evaluate a difference between each candidate motion information and first motion information used to derive the basic predicted signal, and wherein a set of motion information with a minimum cost are used to derive the additional predicted signal.

Clause 28. The method of clause 27, wherein the cost is calculated using at least one of: differences of motion vectors, or reference indexes of candidate motion information and second motion information.

Clause 29. The method of clause 23, wherein motion information used to obtain the additional predicted signal is derived using a template to select one or more motion information from the motion information list.

Clause 30. The method of clause 29, wherein the template comprises a region which comprises at least one of: an adjacent neighboring sample or a non-adjacent neighboring sample.

Clause 31. The method of clause 29, wherein a reference of the template is derived using one motion information of the motion information list, wherein a cost is calculated between the reference and a reconstruction of the template, and wherein motion information with a minimum cost is used to obtain the additional predicted signal.

Clause 32. The method of clause 31, wherein a sum of absolute transformed difference (SATD) between predicted samples of the template and reconstructed samples of the template is calculated and set as the cost.

Clause 33. The method of clause 31, wherein a sum of squared errors between predicted samples of the template and reconstructed samples of the template is calculated and set as the cost.

Clause 34. The method of clause 31, wherein a sum of absolute difference (SAD) is calculated and set as the cost.

Clause 35. The method of clause 31, wherein a mean removal sum of absolute difference (MRSAD) is calculated and set as the cost.

Clause 36. The method of clause 31, wherein a subjective quality metric is calculated and set as the cost.

Clause 37. The method of clause 31, wherein a structural similarity index measure (SSIM) is calculated and set as the cost.

Clause 38. The method of clause 31, wherein the cost is calculated in a form of D+λR, wherein D represents a metric of distortion, R represents the number of bits under consideration and X represents a pre-defined factor.

Clause 39. The method of clause 23, wherein the motion information list is reordered before the motion information list is used to derive the additional predicted signal in the plurality of predicted signals.

Clause 40. The method of clause 39, wherein a template matching base method is applied when reordering the motion information list.

Clause 41. The method of clause 23, wherein a motion vector difference is added to a motion vector of the motion information list before the motion information list is used to derive the additional prediction signal.

Clause 42. The method of clause 1, wherein the coding information comprises at least one of: a reconstructed pixel adjacent to the video unit, a reconstructed pixel non-adjacent to the video unit, a reconstructed sample adjacent to the video unit, a reconstructed sample non-adjacent to the video unit, a reconstructed video unit adjacent to the video unit, or a reconstructed video unit non-adjacent to the video unit.

Clause 43. The method of clause 42, wherein at least one of the followings is used to derive a motion information to obtain the additional predicted signal of the video unit: a reconstructed pixel adjacent to the video unit, a reconstructed pixel non-adjacent to the video unit, a reconstructed sample adjacent to the video unit, a reconstructed sample non-adjacent to the video unit, a reconstructed video unit adjacent to the video unit, or a reconstructed video unit non-adjacent to the video unit.

Clause 44. The method of clause 1, wherein the coding information comprises the basic predicated signal for the video unit.

Clause 45. The method of clause 44, wherein the basic predicted signal is modified by a process to derive an additional predicted signal of the video unit.

Clause 46. The method of clause 45, wherein the process is a filtering method applied to the basic predicted signal.

Clause 47. The method of clause 1, wherein the coding information indicates at least one of: whether the video unit is affine-coded, whether the video unit is subblock-based temporal motion vector prediction (SbTMVP)-coded, whether the video unit is subblock-coded, whether the video unit is local illumination compensation (LIC)-coded, whether the video unit is combined inter and intra prediction (CIIP)-coded, whether the video unit is bi-prediction with coding unit level weight (BCW)-coded, or a BCW index of the video unit.

Clause 48. The method of clause 1, wherein at least one of: the basic predicted signal of the video unit and the additional predicted signal of the video unit is fused to obtain the final predicted signal of the video unit.

Clause 49. The method of clause 48, wherein the basic predicted signal and the additional predicted signal are weighted to obtain the final predicted signal.

Clause 50. The method of clause 49, wherein the final predicted signal is obtained by P=(w₀×P₀+(1−w₀)×P₁)/2, wherein P represents the final predicted signal, w₀ represents a weighting parameter, P₀ represents the basic predicted signal, and P₁ represents the additional predicted signal.

Clause 51. The method of clause 50, wherein the weighting parameter is one of: predefined, derived on the fly, derived in a look-up table, or indicated in the bitstream.

Clause 52. The method of clause 50, wherein the weighting parameter is 0.5.

Clause 53. The method of clause 48, wherein only the additional predicted signal is used to obtain the final predicted signal.

Clause 54. The method of clause 48, wherein the final predicted signal is obtained by: P=Shift(w₀×P₀+((1<<K)−w₀)×P₁, K), wherein K represents an integer, w₀ represents an integer which is not larger than (1<<K), and Shift presents an operation.

Clause 55. The method of clause 54, wherein the operation Shift (x, n) is defined as Shift(x, n)=(x+offset0)>>n, wherein x, n and offset 0 represent variables, respectively.

Clause 56. The method of clause 48, wherein the final predicted signal is obtained by: P=SatShift (w₀×P₀+((1<<K)−w₀)×P₁, K), wherein K represents an integer, w₀ represents an integer which is not larger than (1<<K), and SatShift presents an operation.

Clause 57. The method of clause 56, wherein the operation SatShift (x, n) is defined as

$$SatShift ( x , n ) = \{ \begin{matrix}( x + offset 0 ) >> n & ; & x >= 0 \\ - ( ( - x + offset 1 ) >> n & ; & x < 0\end{matrix} ,$$

wherein x and n represent variables, respectively, and wherein offset0 and/or offset1 are set to (1<<n)>>1 or (1<<(n−1)), or offset0 and/or offset1 are set to 0.

Clause 58. The method of clause 48, wherein a clipping operation is applied to at least one of: the basic prediction signal, the additional predicted signal, or the final predicted signal.

Clause 59. The method of clause 58, wherein the clipping operation is Clip3(a, b, Pxy), wherein a represents an integer, b is denoted as 2\hat{ }B−1, B denotes a bit-depth of a predicted signal, Pxy represents a sample in the predicted signal.

Clause 60. The method of clause 1, wherein the plurality of predicted signals comprises multiple additional predicted signals.

Clause 61. The method of clause 60, wherein the multiple additional predicted signals are derived based on a predetermined number of candidates in a motion candidate list which is constructed for the video unit.

Clause 62. The method of clause 60, wherein the basic predicted signal and the multiple additional predicted signals are weighted to obtain the final predicted signal of the video unit.

Clause 63. The method of clause 62, wherein the final predicted signal is obtained by P=(w₀P₀+ . . . +w₁P₁+ . . . +w_{N} P_{N}))/(1+N), wherein P represents the final predicted signal, P₀ represents the basic predicted signal, P₁ represents the i-th additional predicted signal in the multiple additional predicted signals, i is in a range from 1 to N, N represents the number of additional predicted signals, w₀ represents a weighting parameter for the basic predicted signal, wᵢ represents a weighting parameter for the i-th additional predicted signal, and w_{N} represents a weighting parameter for the n-th additional predicated signal.

Clause 64. The method of clause 63, wherein N is larger than 1.

Clause 65. the method of clause 63, wherein wᵢ is one of: pre-defined, derived on the fly, derived in a look-up table, or indicated in the bitstream.

Clause 66. The method of clause 60, wherein the final predicted signal of the video unit is derived by iteratively weighted the basic predicted signal and the multiple additional predicted signals.

Clause 67. The method of clause 66, wherein the final predicted signal after i iterations is obtained by: P⁽ⁱ⁻¹⁾=((1−wᵢ)×P⁽ⁱ⁻²⁾+wᵢ×Pᵢ)/2, wherein P⁽ⁱ⁻¹⁾ represents the final predicted signal after i iterations, P⁽ⁱ⁻²⁾ represents the final predicted signal after (i−1) iterations, i is in a range from 1 to N, N represents the number of additional predicted signals, and wᵢ represents a weighting parameter for the i-th additional predicted signal, and wherein the final predicted signal after the first iteration is obtained by: P⁽⁰⁾=((1−w₁)×P₀+w₁×P₁)/2, and wherein P⁽⁰⁾ represents the final predicted signal after the first iteration, P₀ represents the basic predicted signal, P₁ represents the first additional predicted signal, and w₁ represents a weighting parameter for the first additional predicted signal.

Clause 68. The method of clause 60, wherein the final predicted signal of the video unit is obtained by: P=Shift(w₀×P₀+w₁×P₁+ . . . w_{N}×P^{N}, K), wherein P represents the final predicted signal, w₀ represents a weighting parameter for the basic predicted signal, P₀ represents the basic predicted signal, w₁ represents a weighting parameter for the first additional predicted signal, P₁ represents the first additional predicted signal, w_{N} represents a weighting parameter for the N-th additional predicted signal, P_{N} represents the N-the additional predicted signal, K is an integer, shift represents an operation.

Clause 69. The method of clause 68, wherein w₀+w₁+ . . . w_{N}=(1<<K).

Clause 70. The method of clause 1, further comprising: determining whether to use the basic predicted signal or a fusion of the plurality of predicted signals as the final predicted signal based on the coding information.

Clause 71. The method of clause 70, wherein a cost is calculated based on the coding information, and whether to use the fusion of the plurality of predicted signals is based on the cost.

Clause 72. The method of clause 71, wherein if the cost is less than or equals to a first threshold, the fusion of the plurality of predicted signals is used; and if the cost is larger than the first threshold, the basic predicted signal is used.

Clause 73. The method of clause 71, wherein if the cost is larger than or equals to a second threshold, the fusion of the plurality of predicted signals is used; and if the cost is less than the second threshold, the basic predicted signal is used.

Clause 74. The method of clause 71, wherein the cost is calculated based on at least one of: a template, the coding information used to obtain the basic predicted signal, or motion information used to obtain the additional predicted signal.

Clause 75. The method of clause 74, wherein a basic template reference signal is derived for a first template using first motion information which is used to derive the basic predicted signal, wherein an additional template reference signal is derived for a second template using second motion information which is used to derive the additional predicted signal, and wherein a fused template reference signal is derived using the same way as the derivation of a fused signal using the basic predicted signal and the additional predicted signal.

Clause 76. The method of clause 74, wherein a first cost is derived using the basic template reference signal and a reconstructed sample of the template, wherein a second cost is derived using a fused template predicted signal and the reconstructed sample of the template, and wherein whether to use the fusion of the plurality of predicted signals for the video unit is determined based on at least one of: the first cost, the second cost, or a fusion of the first and second costs.

Clause 77. The method of clause 76, wherein if an absolute value of a difference between the second cost and the first cost is less than a third threshold, the plurality of predicted signals are used for the video unit; if the absolute value is not less than the third threshold, the basic predicted signal is used for the video unit.

Clause 78. The method of clause 76, wherein if the second cost is less than a third threshold, the plurality of predicted signals are used for the video unit; if the second cost is not less than the third threshold, the basic predicted signal is used for the video unit.

Clause 79. The method of clause 77 or 78, wherein the third threshold is based on at least one of: the first cost or the second cost.

Clause 80. The method of clause 79, wherein the third threshold equals to s*the first cost, wherein s represents a scaling factor.

Clause 81. The method of clause 1, wherein the coding information comprises at least one of: a coding mode, a size of the video unit, a dimension of the video unit, an adjacent neighboring video unit of the video unit, a non-adjacent neighboring video unit of the video unit, or colour components.

Clause 82. The method of clause 81, wherein the plurality of predicted signals are applied to component X, and wherein the component X is at least one of: Y, Cb, or Cr in YCbCr colour formant, or G, B, or R in red-green-blue (RGB) format.

Clause 83. The method of clause 81, wherein a fusion of the basic predicted signal and multiple additional predicted signals is different for different colour components.

Clause 84. The method of clause 1, wherein the non-intra coding mode comprises a coding tool with merge mode in which at least one predicted signal is derived using a merge index indicated in the bitstream.

Clause 85. The method of clause 84, wherein the coding tool with merge mode comprises at least one of: a regular merge mode, a merge mode with motion vector difference (MMVD), a combined inter and intra prediction (CIIP), a geometric prediction mode (GPM), a triangle prediction mode (TPM), a subblock merge prediction, a template matching with merge mode, an affine merge mode with MMVD, a template matching (TM) with merge mode, or a multi-hypothesis merge (MHP).

Clause 86. The method of clause 1, wherein the non-intra coding mode comprises a coding tool with normal inter prediction mode in which at least one predicted signal is derived using at least one of: a motion vector or a motion vector difference, or a reference index indicated in the bitstream.

Clause 87. The method of clause 86, wherein the coding tool with normal inter prediction mode comprises at least one of: an advance motion vector perdition (AMVP) mode, an affine AMVP mode, or a template matching with AMVP mode.

Clause 88. The method of clause 1, wherein if a fusion of the plurality of predicted signals is applied, a target coding tool is not enabled for the video unit.

Clause 89. The method of clause 88, wherein the target coding tool comprises at least one of: a local illumination compensation (LIC), a decoder side motion refinement (DMVR), a multi-pass DMVR, a bi-directional optical flow (BDOF), a sample based BDOF, a prediction refinement with optical flow (PROF), an overlapped block motion compensation (OBMC), an adaptive motion vector resolution (AMVR), a half sample interpolation filter, a subblock transform (SBT), a multiple transform set (MTS), or an affine prediction.

Clause 90. The method of clause 1, wherein a non-intra coding tool is applied to the video unit even a fusion of the plurality of predicted signals is applied to the video unit.

Clause 91. The method of clause 1, further comprising at least one of: determining whether to use a fusion of the plurality of predicted signals for a non-intra coding tool based on the coding information, or determining how to use the fusion of the plurality of predicted signals for the non-intra coding tool based on the coding information.

Clause 92. The method of clause 1, wherein whether to use a fusion of the plurality of predicted signals for a non-intra coding tool is indicated in the bitstream, and/or wherein how to use the fusion of the plurality of predicted signals for the non-intra coding tool is indicated in the bitstream.

Clause 93. The method of clause 1, wherein at least one of the followings is indicated: how to derive an additional predicted signal in the plurality of predicted signals, or the number of additional predicted signals in the plurality of predicted signals.

Clause 94. The method of clause 1, wherein how to fuse at least one of: a basic predicted signal or an additional predicted signal is indicated.

Clause 95. The method of clause 94, wherein an indication of how to fuse at least one of: the basic predicted signal or the additional predicted signal depends on one or more of: picture type, slice type, a dimension size of the video unit, an adjacent neighboring video unit of the video unit, a non-adjacent neighboring video unit of the video unit, or a partitioning depth of the video unit.

Clause 96. The method of clause 1, wherein whether to fuse the plurality of predicted signals depends on at least one of: slice type or picture type.

Clause 97. The method of clause 1, wherein whether to and/or how to fuse the plurality of predicted signals depends on at least one of: a dimension, a size of the video unit, an adjacent neighboring video unit of the video unit, or a non-adjacent neighboring video unit of the video unit.

Clause 98. The method of clause 1, wherein whether to and/or how to fuse the plurality of predicted signals depends on a partitioning depth of the video unit.

Clause 99. The method of clause 1, wherein an indication of dice information for fusing the plurality of predicted signals is indicated based on a condition.

Clause 100. The method of clause 99, wherein the condition is related to at least one of: slice type, picture type, block dimension, depth, or coded mode.

Clause 101. The method of clause 1, wherein the video unit comprises one of: an inter-coded block, an intra block copy (IBC) coded block, or a palette coded block.

Clause 102. The method of clause 1, wherein if a fusion of the plurality of predicted signals is applied to the video unit which is coded by IBC, motion information of the video unit comprises a block vector.

Clause 103. The method of clause 102, wherein the fusion is applied to IBC merge mode, and/or wherein the fusion is applied to normal IBC mode.

Clause 104. The method of clause 1, wherein if a fusion of the plurality of predicted signals is applied to the video unit which is coded by palette mode, motion information of the video unit comprises at least one of: a palette table, a palette entry, or a palette predictor.

Clause 105. The method of clause 1, wherein the conversion includes encoding the target block into the bitstream.

Clause 106. The method of clause 1, wherein the conversion includes decoding the target block from the bitstream.

Clause 107. The method of any of clauses 1-106, wherein the video unit comprises one of: a colour component, a sub-picture, a slice, a tile, a coding tree unit (CTU), a CTU row, a group of CTU, a coding unit (CU), a prediction unit (PU), a transform unit (TU), a coding tree block (CTB), a coding block (CB), a prediction block (PB), a transform block (TB), a block, a sub-block of a block, a sub-region within a block, or a region that contains more than one sample or pixel.

Clause 108. The method of any of clauses 1-106, wherein an indication of whether to and/or how to determine the final predicted based on the plurality of predicted signals is indicated at one of the followings: sequence level, group of pictures level, picture level, slice level, or tile group level.

Clause 109. The method of any of clauses 1-106, wherein an indication of whether to and/or how to determine the final predicted based on the plurality of predicted signals is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 110. The method of any of clauses 1-106, wherein an indication of whether to and/or how to determine the final predicted based on the plurality of predicted signals is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 111. The method of any of clauses 1-106, further comprising: determining, based on coded information of the target block, whether and/or how to determine the final predicted based on the plurality of predicted signals, the coded information including at least one of: the coding mode, a block size, a colour format, a single and/or dual tree partitioning, a colour component, a slice type, or a picture type.

Clause 112. An apparatus for processing video data comprising a processor and a non-transitory memory with instructions thereon, wherein the instructions upon execution by the processor, cause the processor to perform a method in accordance with any of clauses 1-111.

Clause 113. A non-transitory computer-readable storage medium storing instructions that cause a processor to perform a method in accordance with any of clauses 1-111.

Clause 114. A non-transitory computer-readable recording medium storing a bitstream of a video which is generated by a method performed by a video processing apparatus, wherein the method comprises: determining a plurality of predicted signals based on coding information of a video unit, the video unit being coded with a non-intra coding mode, and the plurality predicted signals comprising at least one of: a basic predicted signal or an additional predicted signal; determining a final predicted signal for the video unit based on the plurality of predicted signals; and generating a bitstream of the video unit based on the final predicted signal for the video unit.

Clause 115. A method for storing bitstream of a video, comprising: determining a plurality of predicted signals based on coding information of a video unit, the video unit being coded with a non-intra coding mode, and the plurality predicted signals comprising at least one of: a basic predicted signal or an additional predicted signal; determining a final predicted signal for the video unit based on the plurality of predicted signals; generating a bitstream of the video unit based on the final predicted signal for the video unit; and storing the bitstream in a non-transitory computer-readable recording medium.

### Example Device

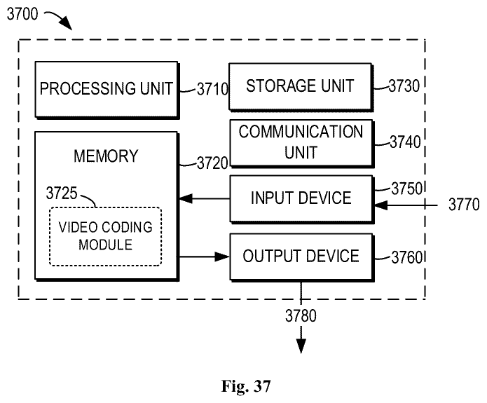

FIG. 37 illustrates a block diagram of a computing device 3700 in which various embodiments of the present disclosure can be implemented. The computing device 3700 may be implemented as or included in the source device 110 (or the video encoder 114 or 200) or the destination device 120 (or the video decoder 124 or 300).

It would be appreciated that the computing device 3700 shown in FIG. 37 is merely for purpose of illustration, without suggesting any limitation to the functions and scopes of the embodiments of the present disclosure in any manner.

As shown in FIG. 37, the computing device 3700 includes a general-purpose computing device 3700. The computing device 3700 may at least comprise one or more processors or processing units 3710, a memory 3720, a storage unit 3730, one or more communication units 3740, one or more input devices 3750, and one or more output devices 3760.

In some embodiments, the computing device 3700 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 3700 can support any type of interface to a user (such as “wearable” circuitry and the like).

The processing unit 3710 may be a physical or virtual processor and can implement various processes based on programs stored in the memory 3720. In a multi-processor system, multiple processing units execute computer executable instructions in parallel so as to improve the parallel processing capability of the computing device 3700. The processing unit 3710 may also be referred to as a central processing unit (CPU), a microprocessor, a controller or a microcontroller.

The computing device 3700 typically includes various computer storage medium. Such medium can be any medium accessible by the computing device 3700, including, but not limited to, volatile and non-volatile medium, or detachable and non-detachable medium. The memory 3720 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 3730 may be any detachable or non-detachable medium and may include a machine-readable medium such as a memory, flash memory drive, magnetic disk or another other media, which can be used for storing information and/or data and can be accessed in the computing device 3700.

The computing device 3700 may further include additional detachable/non-detachable, volatile/non-volatile memory medium. Although not shown in FIG. 37, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 3740 communicates with a further computing device via the communication medium. In addition, the functions of the components in the computing device 3700 can be implemented by a single computing cluster or multiple computing machines that can communicate via communication connections. Therefore, the computing device 3700 can operate in a networked environment using a logical connection with one or more other servers, networked personal computers (PCs) or further general network nodes.

The input device 3750 may be one or more of a variety of input devices, such as a mouse, keyboard, tracking ball, voice-input device, and the like. The output device 3760 may be one or more of a variety of output devices, such as a display, loudspeaker, printer, and the like. By means of the communication unit 3740, the computing device 3700 can further communicate with one or more external devices (not shown) such as the storage devices and display device, with one or more devices enabling the user to interact with the computing device 3700, or any devices (such as a network card, a modem and the like) enabling the computing device 3700 to communicate with one or more other computing devices, if required. Such communication can be performed via input/output (I/O) interfaces (not shown).

In some embodiments, instead of being integrated in a single device, some or all components of the computing device 3700 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 3700 may be used to implement video encoding/decoding in embodiments of the present disclosure. The memory 3720 may include one or more video coding modules 3725 having one or more program instructions. These modules are accessible and executable by the processing unit 3710 to perform the functionalities of the various embodiments described herein.

In the example embodiments of performing video encoding, the input device 3750 may receive video data as an input 3770 to be encoded. The video data may be processed, for example, by the video coding module 3725, to generate an encoded bitstream. The encoded bitstream may be provided via the output device 3760 as an output 3780.

In the example embodiments of performing video decoding, the input device 3750 may receive an encoded bitstream as the input 3770. The encoded bitstream may be processed, for example, by the video coding module 3725, to generate decoded video data. The decoded video data may be provided via the output device 3760 as the output 3780.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
determining, during a conversion between a video unit of a video and a bitstream of the video unit, a plurality of predicted signals based on coding information of the video unit, the video unit being coded with a non-intra coding mode, and the plurality predicted signals comprising at least one of: a basic predicted signal or an additional predicted signal;
determining a final predicted signal for the video unit based on the plurality of predicted signals; and
performing the conversion based on the final predicted signal for the video unit.

2. The method of claim 1, wherein an indication of all additional predicted signals in the plurality of predicted signals is derived using the coding information, or
wherein the basic predicted signal is excluded for the video unit, or
wherein determining the plurality of predicated signals comprises:
constructing a motion candidate list for the video unit;
selecting a predetermined number of candidates from the motion candidate list; and
deriving additional predicted signals in the plurality of predicted signals based on the selected candidates, or
wherein determining the plurality of predicated signals comprises:
constructing a motion candidate list for the video unit;
reordering the motion candidate list;
selecting a predetermined number of candidates from the reordered motion candidate list; and
deriving additional predicted signals in the plurality of predicted signals based on the selected candidates, or
wherein determining the plurality of predicated signals comprises:
constructing a motion candidate list for the video unit;
refining the motion candidate list; and
selecting a predetermined number of candidates from the refined motion candidate list to derive additional predicted signals in the plurality of predicted signals, or
wherein an indication of at least one additional predicted signal in the plurality of predicted signals is derived using the coding information, or
wherein the additional predicted signal in the plurality of predicted signals is derived using the coding information.

3. The method of claim 1, wherein the coding information comprises motion information associated with the video unit.

4. The method of claim 3, wherein the motion information is used to derive the basic predicated signal for the video unit.

5. The method of claim 1, wherein the coding information comprises a motion information list.

6. The method of claim 5, wherein the additional predicted signal in the plurality of predicted signals is derived using at least one motion information in the motion information list except a motion information used to derive the basic predicted signal of the video unit.

7. The method of claim 6, wherein a target motion information at a predefined position in the motion information list is used to derive the additional predicted signal, or
wherein more than one motion information is averaged and used to derive the additional predicted signal, or
wherein a cost is used to evaluate a difference between each candidate motion information and first motion information used to derive the basic predicted signal, and wherein a set of motion information with a minimum cost are used to derive the additional predicted signal.

8. The method of claim 5, wherein motion information used to obtain the additional predicted signal is derived using a template to select one or more motion information from the motion information list.

9. The method of claim 8, wherein the template comprises a region which comprises at least one of: an adjacent neighboring sample or a non-adjacent neighboring sample, or
wherein a reference of the template is derived using one motion information of the motion information list,
wherein a cost is calculated between the reference and a reconstruction of the template, and
wherein motion information with a minimum cost is used to obtain the additional predicted signal.

10. The method of claim 1, wherein the coding information comprises at least one of:
a reconstructed pixel adjacent to the video unit,
a reconstructed pixel non-adjacent to the video unit,
a reconstructed sample adjacent to the video unit,
a reconstructed sample non-adjacent to the video unit,
a reconstructed video unit adjacent to the video unit, or
a reconstructed video unit non-adjacent to the video unit.

11. The method of claim 10, wherein at least one of the followings is used to derive a motion information to obtain the additional predicted signal of the video unit:
a reconstructed pixel adjacent to the video unit,
a reconstructed pixel non-adjacent to the video unit,
a reconstructed sample adjacent to the video unit,
a reconstructed sample non-adjacent to the video unit,
a reconstructed video unit adjacent to the video unit, or
a reconstructed video unit non-adjacent to the video unit.

12. The method of claim 1, wherein at least one of: the basic predicted signal of the video unit and the additional predicted signal of the video unit is fused to obtain the final predicted signal of the video unit.

13. The method of claim 12, wherein the basic predicted signal and the additional predicted signal are weighted to obtain the final predicted signal, or
wherein only the additional predicted signal is used to obtain the final predicted signal, or wherein the final predicted signal is obtained by:
P=Shift(w₀×P₀+((1<<K)−w₀)×P₁,K),
wherein K represents an integer, w₀ represents an integer which is not larger than (1<<K), and Shift presents an operation, or
wherein the final predicted signal is obtained by:
P=SatShift(w₀×P₀+((1<<K)−w₀)×P₁,K),
wherein K represents an integer, w₀ represents an integer which is not larger than (1<<K), and SatShift presents an operation, or
wherein a clipping operation is applied to at least one of:
the basic prediction signal,
the additional predicted signal, or
the final predicted signal.

14. The method of claim 1, wherein the plurality of predicted signals comprises multiple additional predicted signals.

15. The method of claim 14, wherein the multiple additional predicted signals are derived based on a predetermined number of candidates in a motion candidate list which is constructed for the video unit, or
wherein the basic predicted signal and the multiple additional predicted signals are weighted to obtain the final predicted signal of the video unit, or
wherein the final predicted signal of the video unit is derived by iteratively weighted the basic predicted signal and the multiple additional predicted signals, or
wherein the final predicted signal of the video unit is obtained by:
P=Shift(w₀×P₀+w₁×P₁+ . . . w_{N}×P_{N},K),
wherein P represents the final predicted signal, w₀ represents a weighting parameter for the basic predicted signal, P₀ represents the basic predicted signal, w₁ represents a weighting parameter for the first additional predicted signal, P₁ represents the first additional predicted signal, w_{N} represents a weighting parameter for the N-th additional predicted signal, P_{N} represents the N-the additional predicted signal, K is an integer, shift represents an operation.

16. The method of claim 1, wherein if a fusion of the plurality of predicted signals is applied, a target coding tool is not enabled for the video unit.

17. The method of claim 16, wherein the target coding tool comprises at least one of:
a local illumination compensation (LIC),
a decoder side motion refinement (DMVR),
a multi-pass DMVR,
a bi-directional optical flow (BDOF),
a sample based BDOF,
a prediction refinement with optical flow (PROF),
an overlapped block motion compensation (OBMC),
an adaptive motion vector resolution (AMVR),
a half sample interpolation filter,
a subblock transform (SBT),
a multiple transform set (MTS), or
an affine prediction.

18. The method of claim 1, further comprising at least one of:
determining whether to use a fusion of the plurality of predicted signals for a non-intra coding tool based on the coding information, or
determining how to use the fusion of the plurality of predicted signals for the non-intra coding tool based on the coding information, or
wherein whether to use a fusion of the plurality of predicted signals for a non-intra coding tool is indicated in the bitstream, and/or wherein how to use the fusion of the plurality of predicted signals for the non-intra coding tool is indicated in the bitstream, or
wherein at least one of the followings is indicated:
how to derive an additional predicted signal in the plurality of predicted signals, or the number of additional predicted signals in the plurality of predicted signals, or
wherein how to fuse at least one of: a basic predicted signal or an additional predicted signal is indicated, or
wherein whether to fuse the plurality of predicted signals depends on at least one of: slice type or picture type, or
wherein whether to and/or how to fuse the plurality of predicted signals depends on at least one of:
a dimension,
a size of the video unit,
an adjacent neighboring video unit of the video unit, or
a non-adjacent neighboring video unit of the video unit, or
wherein whether to and/or how to fuse the plurality of predicted signals depends on a partitioning depth of the video unit, or
wherein an indication of dice information for fusing the plurality of predicted signals is indicated based on a condition, or
wherein the video unit comprises one of: an inter-coded block, an intra block copy (IBC) coded block, or a palette coded block, or
wherein if a fusion of the plurality of predicted signals is applied to the video unit which is coded by IBC, motion information of the video unit comprises a block vector, or
wherein if a fusion of the plurality of predicted signals is applied to the video unit which is coded by palette mode, motion information of the video unit comprises at least one of: a palette table, a palette entry, or a palette predictor, or
wherein the coding information comprises the basic predicated signal for the video unit, or
wherein the coding information indicates at least one of:
whether the video unit is affine-coded,
whether the video unit is subblock-based temporal motion vector prediction (SbTMVP)-coded,
whether the video unit is subblock-coded,
whether the video unit is local illumination compensation (LIC)-coded,
whether the video unit is combined inter and intra prediction (CIIP)-coded,
whether the video unit is bi-prediction with coding unit level weight (BCW)-coded, or
a BCW index of the video unit, or
the method further comprises: determining whether to use the basic predicted signal or a fusion of the plurality of predicted signals as the final predicted signal based on the coding information, or
wherein the coding information comprises at least one of:
a coding mode,
a size of the video unit,
a dimension of the video unit,
an adjacent neighboring video unit of the video unit,
a non-adjacent neighboring video unit of the video unit, or
colour components, or
wherein the non-intra coding mode comprises a coding tool with merge mode in which at least one predicted signal is derived using a merge index indicated in the bitstream, or
wherein the non-intra coding mode comprises a coding tool with normal inter prediction mode in which at least one predicted signal is derived using at least one of: a motion vector or a motion vector difference, or a reference index indicated in the bitstream, or
wherein a non-intra coding tool is applied to the video unit even a fusion of the plurality of predicted signals is applied to the video unit, or
wherein the conversion includes encoding the target block into the bitstream, or
wherein the conversion includes decoding the target block from the bitstream, or
wherein the video unit comprises one of:
a colour component,
a sub-picture,
a slice,
a tile,
a coding tree unit (CTU),
a CTU row,
a group of CTU,
a coding unit (CU),
a prediction unit (PU),
a transform unit (TU),
a coding tree block (CTB),
a coding block (CB),
a prediction block (PB),
a transform block (TB),
a block,
a sub-block of a block,
a sub-region within a block, or
a region that contains more than one sample or pixel, or
wherein an indication of whether to and/or how to determine the final predicted based on the plurality of predicted signals is indicated at one of the followings:
sequence level,
group of pictures level,
picture level,
slice level, or
tile group level, or
wherein an indication of whether to and/or how to determine the final predicted based on the plurality of predicted signals is indicated in one of the following:
a sequence header,
a picture header,
a sequence parameter set (SPS),
a video parameter set (VPS),
a dependency parameter set (DPS),
a decoding capability information (DCI),
a picture parameter set (PPS),
an adaptation parameter sets (APS),
a slice header, or
a tile group header, or
wherein an indication of whether to and/or how to determine the final predicted based on the plurality of predicted signals is included in one of the following:
a prediction block (PB),
a transform block (TB),
a coding block (CB),
a prediction unit (PU),
a transform unit (TU),
a coding unit (CU),
a virtual pipeline data unit (VPDU),
a coding tree unit (CTU),
a CTU row,
a slice,
a tile,
a sub-picture, or
a region containing more than one sample or pixel, or
wherein the method further comprises:
determining, based on coded information of the target block, whether and/or how to determine the final predicted based on the plurality of predicted signals, the coded information including at least one of:
the coding mode,
a block size,
a colour format,
a single and/or dual tree partitioning,
a colour component,
a slice type, or
a picture type.

19. An apparatus for processing video data comprising a processor and a non-transitory memory with instructions thereon, wherein the instructions upon execution by the processor, cause the processor to perform acts comprising:
determining, during a conversion between a video unit of a video and a bitstream of the video unit, a plurality of predicted signals based on coding information of the video unit, the video unit being coded with a non-intra coding mode, and the plurality predicted signals comprising at least one of: a basic predicted signal or an additional predicted signal;
determining a final predicted signal for the video unit based on the plurality of predicted signals; and
performing the conversion based on the final predicted signal for the video unit.

20. A non-transitory computer-readable storage medium storing instructions that cause a processor to perform acts comprising:
determining, during a conversion between a video unit of a video and a bitstream of the video unit, a plurality of predicted signals based on coding information of the video unit, the video unit being coded with a non-intra coding mode, and the plurality predicted signals comprising at least one of: a basic predicted signal or an additional predicted signal;
determining a final predicted signal for the video unit based on the plurality of predicted signals; and
performing the conversion based on the final predicted signal for the video unit.
